(19) United States
(12) Patent Application Publication
(10) Pub. No.: US 2025/0224735 A1
(43) Pub. Date: Jul. 10, 2025

(54) METHODS AND SYSTEMS FOR CONTROLLING MULTI-UAV COOPERATIVE TRACKING OF GROUND-MOVING TARGETS

(71) Applicant: ZHONGYUAN UNIVERSITY OF TECHNOLOGY, Zhengzhou (CN)

(72) Inventors: Xuzhao CHAI, Zhengzhou (CN); Yongheng ZHAO, Zhengzhou (CN); Sanqiang GAO, Zhengzhou (CN); Baihao QIAO, Zhengzhou (CN); Hui YANG, Zhengzhou (CN); Li YAN, Zhengzhou (CN); Boyang QU, Zhengzhou (CN); Ping LIU, Zhengzhou (CN); Bangsheng FU, Zhengzhou (CN)

(73) Assignee: ZHONGYUAN UNIVERSITY OF TECHNOLOGY, Zhengzhou (CN)

(21) Appl. No.: 19/004,353

(22) Filed: Dec. 29, 2024

(30) Foreign Application Priority Data
Dec. 29, 2023 (CN) 202311870876.7

(51) Int. Cl. G05D 1/644; G05D 1/246; G05D 1/622; G05D 1/686; G05D 1/69; G05D 101/15; G05D 107/13; G05D 109/20; G05D 111/30

(52) U.S. Cl. CPC G05D 1/644; G05D 1/246; G05D 1/622; G05D 1/686; G05D 1/69; G05D 2101/15; G05D 2107/13; G05D 2109/20; G05D 2111/32

(57) ABSTRACT

Disclosed herein are a system and a method for controlling multi-UAV cooperative tracking of a ground-moving target. The system includes UAVs, a processor, and a storage device. The UAVs are wirelessly communicatively connected to the processor. The processor is configured to generate a UAV command transmitted to the UAVs. The UAVs are configured to transmit tracking data to the processor. The processor includes a terrain building module, a flight simulation module, a UAV parameter generation module, a flight trajectory prediction module, a flight trajectory determination module, and a flight trajectory control module. The system provided in the embodiments of the present disclosure integrates Model Predictive Control (MPC) with an Improved Whale Optimization Algorithm (IWOA) to enhance the algorithm's convergence speed and precision, thereby improving the accuracy and stability of target tracking.

### CROSS-REFERENCE TO RELATED APPLICATIONS

This application claims priority to Chinese Patent Application No. 202311870876.7, filed on Dec. 29, 2023, the entire contents of which are incorporated herein by reference.

### TECHNICAL FIELD

The present disclosure relates to the field of intelligent control technology for unmanned aerial vehicles (UAVs), and in particular, to a system and a method for controlling multi-UAV cooperative tracking of a ground-moving target.

### BACKGROUND

A UAV is a kind of flying machine capable of autonomous flight by remote control or equipped with an automatic flight system. UAVs feature advantages such as no risk of human casualties, high flexibility, and low cost. UAVs have been widely used in military and civil applications such as military strikes, target tracking, disaster rescue, and logistics delivery, all of which involve tracking ground targets.

Therefore, it is desired to design a system and a method for controlling multi-UAV cooperative tracking of a ground-moving target, which can be used to improve the stability of the UAVs when tracking a target and to further increase tracking accuracy.

### SUMMARY

One or more embodiments of the present disclosure provide a system for controlling multi-UAV cooperative tracking of a ground-moving target. The system includes: UAVs, a processor, and a storage device. The UAVs are wirelessly communicatively connected to the processor, the processor is configured to generate a UAV command transmitted to the UAVs, and the UAVs are configured to transmit tracking data to the processor. The processor includes a terrain building module, a flight simulation module, a UAV parameter generation module, a flight trajectory prediction module, a flight track determination module, and a flight trajectory control module. The terrain building module is configured to: control the UAVs to fly in a flight area based on a flight environment and the flight area in which the UAVs are flying, collect coordinate information in the flight area, and generate a 3D coordinate map; generate obstacle information based on an area occupied by a building of a building complex, a height of the building, a central position of the building on the ground, a central position area, and a count of buildings of the building complex. The flight simulation module is configured to: generate a first dynamic model based on a horizontal position coordinate, a first velocity, a first heading angle, and a first angular velocity of the ground-moving target, and store the first dynamic model in the storage device, the first dynamic model being configured to characterize a moving characteristic of the ground-moving target; generate a second dynamic model based on a position coordinate, a second velocity, a second heading angle, and a second angular velocity of each of the UAVs, and store the second dynamic model in the storage device, the second dynamic model being configured to characterize a moving characteristic of the UAVs; generate a total cost model for target tracking control based on a horizontal distance model, an obstacle avoidance model, a coverage model, a safety distance model, a communication distance model, and an energy consumption model, and store the total cost model in the storage device. The UAV parameter generation module is configured to: for each of the UAVs, generate a guidance function for an input control variable of the UAV based on a horizontal distance between the UAV and the ground-moving target, a predicted count of steps of a subsequent trajectory of the UAV, an extreme value of the input control variable of the UAV, an angle between a flight direction of the UAV and a moving direction of the ground-moving target, a maximum distance at which the UAV effectively tracks the ground-moving target, the input control variable including the second velocity and the second angular velocity; generate an input constraint for the input control variable; generate a plurality of subsequent control sequences based on the input constraint and the guidance function, while satisfying a performance constraint of each of the UAVs, the performance constraint including at least one of a flight velocity, a turning angle, and a flight altitude of the UAV. The flight trajectory prediction module is configured to: receive current status information of the UAVs transmitted by the UAVs; and predict a plurality of subsequent flight trajectories based on the current status information, the second dynamic model, and the plurality of subsequent control sequences. The flight trajectory determination module is configured to: generate an adaptation value for each of the plurality of subsequent flight trajectories based on the total cost model; generate an optimal subsequent trajectory for the UAVs based on the adaptation value for each the plurality of subsequent flight trajectories. The flight trajectory control module is configured to: send a flight input sequence corresponding to the optimal subsequent trajectory to a corresponding UAV via a mobile network.

One or more embodiments of the present disclosure provide a method for controlling multi-UAV cooperative tracking of a ground-moving target. The method includes: controlling UAVs to fly in a flight area based on a flight environment and the flight area in which the UAVs are flying, collecting coordinate information in the flight area, and generate a three-dimensional (3D) coordinate map; generating obstacle information based on an area occupied by a building of a building complex, a height of the building, a central position of the building on the ground, a central position area, and a count of buildings of the building complex; generating a first dynamic model based on a horizontal position coordinate, a first velocity, a first heading angle, and a first angular velocity of the ground-moving target, and storing the first dynamic model in the storage device, the first dynamic model being configured to characterize a moving characteristic of the ground-moving target. The method further includes: generating a second dynamic model based on a position coordinate, a second velocity, a second heading angle, and a second angular velocity of each of the UAVs, and storing the second dynamic model in the storage device, the second dynamic model being configured to characterize a moving characteristic of the UAVs; generating a total cost model for target tracking control based on a horizontal distance model, an obstacle avoidance model, a coverage model, a safety distance model, a communication distance model, and an energy consumption model, and storing the total cost model in the storage device; for each of the UAVs, generating a guidance function for an input control variable of the UVA based on a horizontal distance between the UAV and the ground-moving target, a predicted count of steps of a subsequent trajectory of the UAV, an extreme value of the input control variable of the UAV, an angle between a flight direction of the UAV and a moving direction of the ground-moving target, a maximum distance at which the UAV effectively tracks the ground-moving target, the input control variable including the second velocity and the second angular velocity. The method further includes: generating an input constraint for the input control variable; generating a plurality of subsequent control sequences based on the input constraint and the guidance function, while satisfying a performance constraint of each of the UAVs, the performance constraint including at least one of a flight velocity, a turning angle, and a flight altitude of the UAV; receiving current status information of the UAVs transmitted by the UAVs; predicting a plurality of subsequent flight trajectories based on the current status information, the second dynamic model, and the plurality of subsequent control sequences; generating an adaptation value for each of the plurality of subsequent flight trajectories based on the total cost model; generating an optimal subsequent trajectory for the UAVs based on adaptation values for the plurality of subsequent flight trajectories; and sending a flight input sequence corresponding to the optimal subsequent trajectory to a corresponding UAV via a mobile network.

### BRIEF DESCRIPTION OF THE DRAWINGS

The present disclosure will be further illustrated by way of exemplary embodiments, which will be described in detail by the accompanying drawings. These embodiments are not limiting, and in these embodiments, the same numbering denotes the same structure, wherein:

FIG. 1 is a block diagram illustrating exemplary modules of a processor of a system for controlling multi-UAV cooperative tracking of a ground-moving target according to some embodiments of the present disclosure;

FIG. 2 is a flowchart illustrating an exemplary process for updating a flight control sequence of an associated UAV according to some embodiments of the present disclosure;

FIG. 3 is s flowchart illustrating an exemplary process for adjusting a probability of randomly selecting a predation mode according to some embodiments of the present disclosure;

FIG. 4A is a schematic diagram illustrating trajectories of UAVs tracking a ground-moving target, obtained using an MPC+IWOA approach according to some embodiments of the present disclosure;

FIG. 4B is a schematic diagram illustrating trajectories of UAVs tracking a ground-moving target, obtained using an MPC+GWO approach according to some embodiments of the present disclosure;

FIG. 5A is a time graph illustrating a failure to track a ground-moving target using an MPC+IWOA approach according to some embodiments of the present disclosure;

FIG. 5B is a time graph illustrating a failure to track a ground-moving target using an MPC+GWO approach according to some embodiments of the present disclosure;

FIG. 6 shows velocity changes of UAVs during a tracking process using an MPC+IWOA approach according to some embodiments of the present disclosure;

FIG. 7 shows velocity changes of UAVs during a tracking process using an MPC+GWO approach according to some embodiments of the present disclosure;

FIG. 8A is a diagram illustrating a result of flight distances between UAVs, obtained using an MPC+IWOA approach according to some embodiments of the present disclosure; and

FIG. 8B is a diagram illustrating a result of flight distances between UAVs, obtained using an MPC+GWO approach according to some embodiments of the present disclosure.

### DETAILED DESCRIPTION

The accompanying drawings that are to be used in the description of the embodiments are briefly described below.

UAVs should achieve continuous tracking of a moving target as much as possible when performing a task of tracking a target. However, a flight environment for the UAVs tracking the target is a complex three-dimensional scenario, which presents challenges such as a line-of-sight of the UAV being obstructed by obstacles and a spatial constraint between the UAV and the target. In addition, the flyability under dynamic constraints of the UAVs needs to be considered. Most studies focus only on issues such as target tracking in simple or free environments, which may be overly idealistic for the UAVs in various applications. During the tracking process in real environments, not only the constraints of airframe performance of the UAVs should be considered, but also moving targets should be detected by the UAVs as much as possible. Furthermore, when multiple UAVs tracks a moving target, cooperative coordination among the UAVs must be addressed to ultimately achieve the goal of the UAVs being able to continuously track the target for extended periods.

Currently, model predictive control (MPC) is commonly used as a control approach for the target tracking. MPC is a widely applied control approach, but when solving optimization problems, the choice of parameters and the introduction of constraints may significantly increase computational load, which may lead to a decline in performance. To address the solution challenges of MPC, approaches combining MPC and intelligent algorithms are widely used to enhance the effectiveness of tracking ground-moving targets using multiple UAVs. In these approaches, MPC serves as a solution framework for multi-UAV tracking of moving targets, allowing for real-time prediction of trajectories of the UAVs over a limited time period, and the intelligent algorithms serve as solvers for model predictions. A whale optimization algorithm (WOA), with the advantages of simple operation, fewer adjusted parameters, and the ability to find the optimal solution quickly, has been effective in various fields. However, the WOA has drawbacks for target tracking problems, such as slow convergence speed, low solution precision, and a tendency to get stuck in local optima.

Therefore, there is an urgent need to design a method for controlling multi-UAV cooperative tracking of a ground-moving target to enhance the stability of multi-UAV target tracking and further improve tracking accuracy.

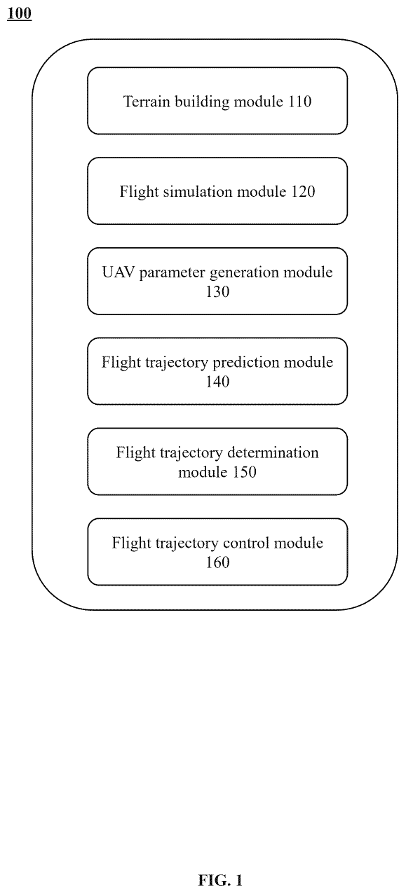

FIG. 1 is a block diagram illustrating exemplary modules of a processor of a system for controlling multi-UAV cooperative tracking of a ground-moving target according to some embodiments of the present disclosure. The system for controlling multi-UAV cooperative tracking of the ground-moving target includes UAVs, a processor, and a storage device.

A UAV refers to a vehicle that is operated by a remote control or an autonomous control system. In some embodiments, the UAV may include a remotely controlled UAV, an autonomous UAV, or the like.

The storage device refers to a device or medium used in the system to store data and commands from the UAVs. In some embodiments, the storage device may include a primary storage device (e.g., main memory), a secondary storage device (e.g., external memory), a cache storage device, or the like.

The processor refers to a core hardware in the system that is responsible for executing a UAV command and processing data. In some embodiments, the processor may include, but is not limited to, a central processing unit (CPU), a graphics processing unit (GPU), a field programmable gate array (FPGA), or the like.

In some embodiments, the UAVs may be wirelessly communicatively connected to the processor. The processor may be configured to generate the UAV command transmitted to the UAVs. The UAVs may be configured to transmit tracking data to the processor.

The UAV command refer to a series of commands sent to the UAVs from a ground control station or autonomous control system.

The tracking data refers to information that is captured by the UAVs through sensors, communication modules, and other devices and transmitted to the processor. In some embodiments, the tracking data may include whether each of the UAVs recognizes the ground-moving target, a distance of each of the UAVs from the ground-moving target, wind force and direction data, flight altitude data, a current energy level, or the like. More details regarding the tracking data and the current energy level may be found in later descriptions.

In some embodiments, as shown in FIG. 1, the processor includes a terrain building module 110, a flight simulation module 120, a UAV parameter generation module 130, a flight trajectory prediction module 140, a flight trajectory determination module 150, and a flight trajectory control module 160.

In some embodiments, the terrain building module 110 is configured to: control the UAVs to fly in a flight area based on a flight environment and the flight area in which the UAVs are flying, collect coordinate information in the flight area, generate a 3D coordinate map, generate obstacle information based on an area occupied by a building of a building complex, a height of the building, a central position of the building on the ground, a central position area, and a count of buildings of the building complex.

The flight environment refers to various conditions and factors encountered by the UAVs in the flight area. In some embodiments, the flight environment may include, but is not limited to, terrain, meteorological conditions, electromagnetic interference, airspace control, obstacle distribution, or the like. In some embodiments, the flight environment may be obtained based on real-time environmental sensing through different modules and sensors carried by the UAVs, such as a Global Positioning System (GPS), an Inertial Measurement Unit (IMU), a Lidar, a camera, a vision sensor, or the like. In some embodiments, the flight environment may be obtained by the UAVs accessing to an external data source. For example, the UAVs may have access to a weather station, a geographic information system (GIS), or the like. In some embodiments, the processor may use an urban topography as the flight environment for multi-UAV target tracking.

The flight area refers to a spatial range in which the UAVs are able to perform flight operations. In some embodiments, the flight area is typically defined by boundary constraints in directions of an X-axis, a Y-axis, and a Z-axis. In some embodiments, the processor may set the boundary constraints for the flight area based on the flight environment, and obtain the flight area based on the boundary constraints. The boundary constraints include a boundary constraint on the X-axis and the Y-axis in a horizontal plane, and a boundary constraint on the Z-axis.

The 3D coordinate map is constructed by the processor in the flight area using the X-axis and the Y-axis of the ground area, and the flight altitude above the ground area as the Z-axis.

In some embodiments, the processor may control the UAVs to fly in the flight area based on the flight environment and the flight area in which the UAV is flying to collect the coordinate information within the flight area, thereby generating the 3D coordinate map.

The area occupied by the building of the building complex refers to a projected range of the building on the ground and an actual occupied volume of the building in the 3D coordinate map. The height of the building refers to a vertical distance from the ground to a highest point of the building, usually represented by a highest height of all buildings in the area occupied by the building complex. The central position of the building of the building complex on the ground refers to a function of the central position (x, y) of the building of the building complex on the ground. The central position area refers to an area in which the central position of the building is located. For example, the central position area may be an area formed by a threat boundary.

In some embodiments, the terrain building module 110 may determine the threat boundary and the height of the building complex by approximating a threat area of the building complex as a rectangular area, thereby generating obstacle information.

In some embodiments, the obstacle information may be determined using Equation (1):

$$ξ = {⋃}_{B = 1}^{B = {N}_{1}} {ξ}_{B} , {ξ}_{B} = F ( {H}_{B} , ( x , y ) ) ∈ {\overline{X}}_{B} , \qquad ( 1 )$$

wherein, ξ_{B} denotes the area occupied by any one of the buildings of the building complex, as function of the height H_{B} of the building and the central position (x, y) of the building on the ground, X̅_{B} denotes the central position area, and N₁ denotes a count of the buildings of the building complex.

In some embodiments, the flight simulation module 120 is configured to: generate a first dynamic model based on a horizontal position coordinate, a first velocity, a first heading angle, and a first angular velocity of the ground-moving target, and store the first dynamic model in the storage device. The flight simulation module 120 is further configured to: generate a second dynamic model based on a position coordinate, a second velocity, a second heading angle, and a second angular velocity of each of the UAVs, and store the second dynamic model in the storage device. The flight simulation module 120 is further configured to: generate a total cost model for target tracking control based on a horizontal distance model, an obstacle avoidance model, a coverage model, a safety distance model, a communication distance model, and an energy consumption model, and store the total cost model in the storage device.

The ground-moving target refers to an object that is located on the ground and has the ability to move autonomously.

The horizontal position coordinate refers to a position of the ground-moving target on the ground, typically expressed as (x, y) in a two-dimensional (2D) coordinate system. The first velocity refers to a velocity at which the ground-moving target moves in a horizontal direction. The first heading angle refers to an angle between a forward direction of the ground-moving target and a reference direction (e.g., due north). The first angular velocity refers to a steering velocity of the ground-moving target.

In some embodiments, the first dynamic model is configured to characterize a moving characteristic of the ground-moving target.

In some embodiments, without considering an influence of external factors on the movement of the UAVs, the first dynamic model under an inertial system may be represented by Equation (2):

$${\dot{x}}_{T} = {v}_{T} sin {θ}_{T} , {\dot{y}}_{T} = {v}_{T} cos {θ}_{T} , {\dot{θ}}_{T} = {ω}_{T} , \qquad ( 2 )$$

wherein (x_{T}, y_{T}) denotes the horizontal position coordinate of the ground-moving target; and ν_{T}, θ_{T}, ω_{T} denote the first velocity, the first heading angle, and the first angular velocity, respectively.

The position coordinate of a UAV refers to a current position of the UAV in the 3D coordinate map. The second velocity of a UAV refers to a linear velocity of the UAV in the 3D coordinate map. The second heading angle of a UAV refers to an angle between a forward direction and a reference direction of the UAV. The second angular velocity of a UAV refers to a rotating velocity of the UAV around three axes (i.e., a pitch axis, a roll axis, and a yaw axis).

In some embodiments, the second dynamic model is configured to characterize a moving characteristic of the UAVs.

In some embodiments, assuming that the UAVs fly at a fixed altitude between urban buildings, without considering the influence of the external factors on the movement of the UAVs, the second dynamic model may be represented by Equation (3):

$${\dot{x}}_{ι} = {v}_{i} sin {θ}_{i} , {\dot{y}}_{ι} = {v}_{i} cos {θ}_{i} , {\dot{z}}_{ι} = 0 , {\dot{θ}}_{ι} = {ω}_{i} , \qquad ( 3 )$$

wherein xᵤᵢ=(xᵢ, yᵢ, zᵢ) denotes the position coordinate of an i^{th} UAV; νᵢ and θᵢ denote an i^{th} second velocity and an i^{th} second heading angle, respectively; ωᵢ denotes an i^{th} second angular velocity; rᵢ=(νᵢ, ωᵢ) denotes an input control variable of the i^{th} UAV, i=1, 2, . . . , N₂, N₂ denotes a count of the UAVs.

In some embodiments, in complex urban environments, a presence of the buildings may cause an obstructed line-of-sight of the UAVs, resulting in an inability of the UAVs to detect the ground-moving target. Therefore, to ensure the stability in the UAVs' tracking of the ground-moving target, the processor may construct a horizontal distance model.

In some embodiments, the horizontal distance model may be represented by Equation (4):

$${J}_{D} = \{ \begin{matrix}{\sum }_{j = k}^{k + {N}_{4} - 1} {\sum }_{i = 1}^{{N}_{2}} \frac{{l}_{iT} ( j )}{L} & {l}_{iT} < L \\ {\sum }_{j = k}^{k + {N}_{4} - 1} {\sum }_{i = 1}^{{N}_{2}} {l}_{iT} ( j ) & {l}_{iT} > L\end{matrix} , {l}_{iT} = \sqrt{{( {x}_{{U}_{i}} - {x}_{T} )}^{2} - {( {y}_{{U}_{i}} - {y}_{T} )}^{2}} , \qquad ( 4 )$$

wherein J_{D} denotes a horizontal distance cost between the UAVs and the ground-moving target in a horizontal plane, N₄ denotes a predicted count of steps of the movement of the UAV, N₂ denotes the count of the UAVs, l_{iT} denotes a horizontal distance between the i^{th} UAV and the ground-moving target, and L is a constant.

In some embodiments, the UAVs track the ground-moving target in an urban environment, and the UAVs are required to avoid building complexes, high-altitude facilities, etc., in the city during the target tracking. To ensure the flight safety, the processor may design an obstacle avoidance model for a flight process of the UAVs.

In some embodiments, the obstacle avoidance model may be represented by Equation (5):

$${J}_{OA} = {\sum }_{j = k}^{k + {N}_{4} - 1} {\sum }_{i = 1}^{{N}_{U}} {g}_{i} ( j ) , {g}_{i} = \{ \begin{matrix}0 & {p}_{c} ( {h}_{nfz} - {z}_{{U}_{i}} ) < 0 \\ ∞ & {p}_{c} ( {h}_{nfz} - {z}_{{U}_{i}} ) > 0\end{matrix} , \qquad ( 5 )$$

wherein J_{OA} denotes an obstacle avoidance cost between the UAVs and an obstacle, gᵢ denotes a penalty function for the collision of the UAVs with a building of the building complex, h_{nfz} denotes a height of the obstacle, z_{U}_{ᵢ} denotes a flight altitude of the i^{th} UAV; p_{c} denotes a probability of collision between the UAVs and the building in the horizontal direction. If the UAVs collide with a boundary of the building, p_{c}=1, if the UAVs do not collide with the boundary of the building, p_{c}=0.

In some embodiments, the multi-UAV target tracking process requires that the UAVs may detect and track the ground-moving target as long as the ground-moving target is located within a coverage area of the sensor of any one of the UAVs and the UAVs have an unobstructed line-of-sight. Thus, the processor may construct a coverage model.

In some embodiments, the coverage model may be represented by Equation (6):

$${J}_{C} = \{ \begin{matrix}{\sum }_{j = k}^{k + {N}_{4} - 1} {\sum }_{i = 1}^{{N}_{U}} {P}_{i} {P}_{T} ( j ) & ∃ i \vert {P}_{i} > p and {P}_{T} = 1 \\ 0 & else\end{matrix} , \qquad ( 6 )$$

$${P}_{i} = ρ * exp ( - c ( {( {x}_{{U}_{i}} - {x}_{T} )}^{2} + {( {y}_{{U}_{i}} - {y}_{T} )}^{2} + {( {z}_{{U}_{i}} - {z}_{T} )}^{2} ) ) ,$$

$${P}_{T} = \{ \begin{matrix}0 & the UAVs having an obstructed line - \\ & of sight to the ground - moving target \\ 1 & the UAVs having an unobstructed line - \\ & of sight to the ground - moving target\end{matrix} ,$$

wherein J_{C} denotes a target coverage cost of the target tracking of the UAVs, Pᵢ denotes a probability that the ground-moving target is detected by the i^{th} UAV, p denotes a probability that the UAVs detect the ground-moving target, P_{T} denotes a probability of the line-of-sight between the UAVs and the ground-moving target being obstructed, (x_{U}_{ᵢ}, y_{U}_{ᵢ}, z_{U}_{ᵢ}) denotes a position coordinate of the i^{th} UAV, and (x_{T}, y_{T}, z_{T}) denotes a position coordinate of the ground-moving target.

In some embodiments, during the multi-UAV target tracking process, maintaining a certain flight distance between the UAVs not only prevents collisions between the UAVs due to airframe performance constraint, but also improves the probability of the ground-moving target being detected. Therefore, the processor may construct a safety distance model.

In some embodiments, the safety distance model may be represented by Equation (7):

$${J}_{SD} = {\sum }_{j = k}^{k + {N}_{4} - 1} {\sum }_{i = 1}^{{N}_{U}} {f}_{SDi} ( j ) , {f}_{SDi} = \frac{1}{2} [ 1 - tanh ( \frac{{d}_{ij} - {d}_{min} - \frac{Δ d}{2}}{\frac{Δ d}{8}} ) ] , \qquad ( 7 )$$

wherein J_{SD} denotes a safety distance cost between the UAVs, dᵢⱼ denotes a distance between the i^{th} UAV and a j^{th} UAV, dₘᵢₙ denotes a minimum safe distance between the UAVs, and Δd denotes a buffer distance of the UAVs.

In some embodiments, each of the UAVs independently tracks the ground-moving target and a locally optimal flight trajectory is obtained for each UAV. To realize multi-UAV cooperative tracking, the UAVs need to exchange their status information and detected information. Therefore, to facilitate cooperation between the UAVs, the processor may construct a communication distance model.

In some embodiments, the communication distance model may be represented by Equation (8):

$${J}_{CD} = {\sum }_{j = k}^{k + {N}_{4} - 1} {\sum }_{i = 1}^{{N}_{U}} {f}_{CDi} ( j ) , {f}_{CDi} = \frac{1}{2} [ 1 + tanh ( \frac{{d}_{ij} - {d}_{max} + \frac{Δ d}{2}}{\frac{Δ d}{8}} ) ] , \qquad ( 8 )$$

wherein J_{CD} denotes a communication distance cost between the UAVs, dᵢⱼ denotes the distance between the i^{th} UAV and the j^{th} UAV, dₘₐₓ denotes a maximum communication distance between the UAVs, and Δd denotes the buffer distance of the UAVs.

In some embodiments, the time of tracking the ground-moving target is uncertain and the UAVs have limited energy, so the smaller the energy consumption of the UAVs, the longer the tracking time, and the smaller the change in input control variables of the UAVs, the smaller the energy consumption, and the smoother the flight status of the UAVs may be. Therefore, the processor may construct an energy consumption model.

In some embodiments, the energy consumption model may be represented by Equation (9):

$${J}_{EC} = {\sum }_{j = k}^{k + {N}_{4} - 1} {\sum }_{i = 1}^{{N}_{U}} \frac{‖ {v}_{i} ( j ) - {v}_{i} ( j - 1 ) ‖}{{v}_{max} - {v}_{min}} + \frac{‖ {ω}_{i} ( j ) - {ω}_{i} ( j - 1 ) ‖}{{ω}_{max} - {ω}_{min}} , \qquad ( 9 )$$

wherein J_{EC} denotes an energy consumption cost of the target tracking of the UAVs, ωᵢ and νᵢ denote the input control variables of the UAVs, νₘₐₓ denotes a maximum velocity of the UAVs, νₘᵢₙ denotes a minimum velocity of the UAVs, ωₘₐₓ denotes a maximum angular velocity of the UAVs, and ωₘᵢₙ denotes a minimum angular velocity of the UAVs.

The total cost model for target tracking control refers to a mathematical model for comprehensively evaluating and optimizing a plurality of performance metrics of the UAVs while performing a target tracking task. In some embodiments, the total cost model may be constructed based on a weighted algebraic sum of the horizontal distance model, denoted as J_{D}, the obstacle avoidance model, denoted as J_{OA}, the coverage model, denoted as J_{C}, the safety distance model, denoted as J_{SD}, the communication distance model, denoted as J_{CD}, and the energy consumption model, denoted as J_{EC}.

In some embodiments, the total cost model may be represented by Equation (10):

$${f}_{N , G} = {m}_{1} \cdot {J}_{D} + {m}_{2} \cdot {J}_{OA} + {m}_{3} \cdot {J}_{C} + {m}_{4} \cdot {J}_{SD} + {m}_{5} \cdot {J}_{CD} + {m}_{6} \cdot {J}_{EC} , \qquad ( 10 )$$

wherein m₁, m₂, m₃, m₄, m₅, and m₆ denote first weight coefficients of each cost.

The each cost refers to costs determined from the horizontal distance model J_{D}, the obstacle avoidance model J_{OA}, the coverage model J_{C}, the safety distance model J_{SD}, the communication distance model J_{CD}, and the energy consumption model J_{EC}. For example, the each cost includes the horizontal distance cost, the obstacle avoidance cost, the target coverage cost, the safety distance cost, the communication distance cost, and the energy consumption cost.

In some embodiments, the processor may set the first weight coefficients based on experience. For example, the processor, in order to ensure the UAVs track accurately and in a timely manner, may set the first weight coefficients for the coverage model and the horizontal distance model to be greater than the first weight coefficients for other costs. It may be understood that, the most important aspect of the target tracking is that the UAVs are able to accurately track the ground-moving target, and secondly, the horizontal distance between the UAVs and the ground-moving target increases the probability that the UAVs detect the ground-moving target. In addition, the flight safety, whether information is exchanged in time, and the tracking duration of the UAVs may also be taken into account. Therefore, the first weight coefficients of the obstacle avoidance model, the safety distance model, the communication distance model, and the energy consumption model may be lower than the first weight coefficients of the coverage model and the horizontal distance model.

In some embodiments, the processor obtains historical tracking data transmitted by the UAVs to the processor, and dynamically adjusts the first weight coefficient of the each cost based on a change of the historical tracking data.

The historical tracking data refers to the tracking data of the UAVs against the ground-moving target during a past time period. For example, the historical tracking data may include whether the UAVs recognize the ground-moving target, the distance between the UAVs and the ground-moving target, or the like, at a plurality of historical time points.

In some embodiments, the change of the historical tracking data may include at least one of a change in a determination result of whether the UAVs recognize the ground-moving target and a change in the distance between the UAVs and the ground-moving target over time. In some embodiments, the processor may generate a magnitude of change based on an amount of the change in the distance between the UAVs and the ground-moving target over time. The magnitude of change refers to a degree of the change of the historical tracking data between different time points.

In some embodiments, the processor may determine the change of the historical tracking data by counting the historical tracking data for a plurality of consecutive historical time points. The plurality of consecutive historical time points refer to a plurality of consecutive time points since a last adjustment of the first weight coefficients. For example, the processor may generate the magnitude of change of the historical tracking data at a time point of the plurality of consecutive historical time points relative to a first time point of the plurality of consecutive historical time points. The magnitude of change may include a magnitude of change in the distance between the UAVs and the ground-moving target, etc.

In some embodiments, the processor may obtain the tracking data of the UAVs each time an optimal subsequent trajectory is determined. It should be noted that the processor does not adjust the first weight coefficients each time the optimal subsequent trajectory is determined.

In some embodiments, the processor may adjust one or more of the first weight coefficients corresponding to the costs in various ways.

For example, the processor may generate a first weight coefficient for an adjusted target coverage cost according to Equation (11):

$${m}_{31} = {m}_{3} \times ( 1 - Δ L ) , \qquad ( 11 )$$

wherein m₃₁ denotes a first weight coefficient of the target coverage cost after an adjustment, m₃ denotes a first weight coefficient of the target coverage cost before the adjustment, and ΔL denotes the magnitude of change in the distance between the UAVs and the ground-moving target.

In some embodiments, the first weight coefficient corresponding to the energy consumption cost may be negatively correlated to a current energy level (e.g., a current power percentage) of one of the UAVs or the entire UAVs. More details regarding the current energy level may be found in later descriptions of FIG. 1 and related descriptions. For example, the processor may generate a first weight coefficient corresponding to an adjusted energy consumption cost using Equation (12):

$${m}_{61} = {m}_{6} \times ( 2 - E ) , \qquad ( 12 )$$

wherein m₆₁ denotes the first weight coefficient of the energy consumption cost after an adjustment, m₆ denotes a first weight coefficient of the energy consumption cost before the adjustment, and E denotes the current energy level.

In some embodiments, after adjusting the first weight coefficient corresponding to one or more of the costs, the other first weight coefficients that has not been adjusted may be proportionally adjusted according to their original values.

In some embodiments of the present disclosure, the processor dynamically adjusts the first weight coefficients corresponding to different costs by analyzing the priority (e.g., trying to ensure that the target is not lost, ensuring power saving, avoiding damages, etc.) of the UAVs' current flight, thereby ensuring the effectiveness of multi-UAV flight control.

In some embodiments, the UAV parameter generation module 130 is configured to: for each of the UAVs, generate a guidance function for the input control variable of the UAV based on the horizontal distance between the UAV and the ground-moving target, a predicted count of steps of a subsequent trajectory of the UAV, an extreme value of the input control variable of the UAV, an angle between a flight direction of the UAV and a moving direction of the ground-moving target, and a maximum distance at which the UAV effectively tracks the ground-moving target, wherein the input control variable includes the second velocity and the second angular velocity. The UAV parameter generation module 130 is configured to: generate an input constraint for the input control variable, and generate a plurality of subsequent control sequences based on the input constraint and the guidance function, while satisfying a performance constraint of the UAVs, the performance constraint including at least one of a flight velocity, a turning angle, and a flight altitude of the UAVs.

The predicted count of steps of the subsequent trajectory of the UAV refers to a count of time steps in the predicted flight path of the UAV over a future period of time. In some embodiments, the predicted count of steps of the subsequent trajectory of the UAV may be set artificially. The predicted count of steps M of the subsequent trajectory of the UAV may be set as an integer between 1 and N4, wherein N4 denotes a predicted count of steps of the movement of the UAV.

The extreme value of the input control variable refers to a maximum value and a minimum value of the input control variable (e.g., a velocity, an angular velocity, etc.) of the UAV. In some embodiments, the extreme value of the input control variable may be determined based on parameters provided by a manufacturer of the UAV.

The maximum distance at which effective tracking is performed refers to a furthest distance at which the UAV is able to maintain effective tracking of the ground-moving target. In some embodiments, the maximum distance may be determined based on specification parameters of the sensor carried by the UAV.

The guidance function refers to an algorithm used to instruct the UAV how to adjust the input control variable during flight to achieve the target tracking. In some embodiments, a mathematical model of the guidance function may be represented by Equation (13):

$${g}_{M} = \frac{1}{( 1 + {e}^{( c θ r )} )} ( ub - lb ) + lb if d > l , \qquad ( 13 )$$

wherein d denotes the horizontal distance between the UAV and the ground-moving target, M denotes the predicted count of steps of the subsequent trajectory of the UAV, ub and lb denote the maximum value and the minimum value of the input control variable, respectively, θ denotes the angle between the flight direction of the UAV and the moving direction of the ground-moving target, and l denotes the maximum distance at which the UAV effectively tracks the ground-moving target, determined based on a type of the sensor of the UAV; c denotes a constant parameter, and r is a random number in (0,1).

The input constraint of a UAV refers to a limit on the input control variable of the UAV to ensure that the UAV does not exceed a physical limit or a safety range during flight. The performance constraint of a UAV refers to a performance requirement that the UAV must meet while performing a mission.

In some embodiments, the performance constraint of a UAV includes the flight velocity, the turning angle, and the flight altitude of the UAV, and the input control variable includes the second velocity νᵢ and the second angular velocity ωᵢ.

In some embodiments, the constraints for the input control variable and the guidance function. Under the condition that the performance constraints of the UAVs are satisfied, N3 subsequent control sequences are randomly generated based on the constraints for the input control variable and the guidance function.

In some embodiments, N subsequent control sequences may be represented as:

$$( {v}_{1 , i} , {ω}_{1 , i} ) , ( {v}_{1 , i + 1} , {ω}_{1 , i + 1} ) , ( {v}_{1 , i + 2} , {ω}_{1 , i + 2} ) , … , ( {v}_{1 , i + M} , {ω}_{1 , i + M} ) , \\ ( {v}_{2 , i} , {ω}_{2 , i} ) , ( {v}_{2 , i + 1} , {ω}_{2 , i + 1} ) , ( {v}_{2 , i + 2} , {ω}_{2 , i + 2} ) , … , ( {v}_{2 , i + M} , {ω}_{2 , i + M} ) , \\ ( {v}_{3 , i} , {ω}_{3 , i} ) , ( {v}_{2 , i + 1} , {ω}_{2 , i + 1} ) , ( {v}_{3 , i + 2} , {ω}_{3 , i + 2} ) , … , ( {v}_{3 , i + M} , {ω}_{3 , i + M} ) , \\ … \\ ( {v}_{N , i} , {ω}_{N , i} ) , ( {v}_{N , i + 1} , {ω}_{N , i + 1} ) , ( {v}_{N , i + 2} , {ω}_{N , i + 2} ) , … , ( {v}_{N , i + M} , {ω}_{N , i + M} ) ;$$

wherein N denotes a number of a predicted trajectory, N∈[1, N3].

In some embodiments, the flight trajectory prediction module 140 is configured to: receive current status information of the UAVs transmitted by the UAVs, and predict a plurality of subsequent flight trajectories based on the current status information, the second dynamic model, and the plurality of subsequent control sequences.

The current status information refers to real-time flight-related data of the UAVs at a current moment. In some embodiments, the current status information may include information such as a position, a velocity, an attitude, an environment, or the like of the UAVs. In some embodiments, the flight trajectory prediction module 140 may obtain information such as the position, the velocity, the attitude, or the like of the UAVs through the sensors carried by the UAVs. In some embodiments, the current status information may be obtained through an external data source. For example, the processor may obtain environmental information through a weather station, etc.

The subsequent flight trajectories refer to flight paths that the UAVs execute at a future time. In some embodiments, the processor may obtain a predicted N subsequent flight trajectories based on the obtained N subsequent control sequences, according to the current status information of the UAVs and the second dynamic model.

In some embodiments, N predicted subsequent flight trajectories may be expressed as:

$$( {x}_{1 , i} , {y}_{1 , i} , {z}_{1 , i} , {φ}_{1 , i} ) , ( {x}_{1 , i + 1} , {y}_{1 , i + 1} , {z}_{1 , i + 1} , {φ}_{1 , i + 1} ) , \\ ( {x}_{1 , i + 2} , {y}_{1 , i + 2} , {z}_{1 , i + 2} , {φ}_{1 , i + 2} ) , … , ( {x}_{1 , i + M} , {y}_{1 , i + M} , {z}_{1 , i + M} , {φ}_{1 , i + M} ) , \\ ( {x}_{2 , i} , {y}_{2 , i} , {z}_{2 , i} , {φ}_{2 , i} ) , ( {x}_{2 , i + 1} , {y}_{2 , i + 1} , {z}_{2 , i + 1} , {φ}_{2 , i + 1} ) , \\ ( {x}_{2 , i + 2} , {y}_{2 , i + 2} , {z}_{2 , i + 2} , {φ}_{2 , i + 2} ) , … , ( {x}_{2 , i + M} , {y}_{2 , i + M} , {z}_{2 , i + M} , {φ}_{2 , i + M} ) , \\ ( {x}_{3 , i} , {y}_{3 , i} , {z}_{3 , i} , {φ}_{3 , i} ) , ( {x}_{3 , i + 1} , {y}_{3 , i + 1} , {z}_{3 , i + 1} , {φ}_{3 , i + 1} ) , \\ ( {x}_{3 , i + 2} , {y}_{3 , i + 2} , {z}_{3 , i + 2} , {φ}_{3 , i + 2} ) , … , ( {x}_{3 , i + M} , {y}_{3 , i + M} , {z}_{3 , i + M} , {φ}_{3 , i + M} ) , \\ … \\ ( {x}_{N , i} , {y}_{N , i} , {z}_{N , i} , {φ}_{N , i} ) , ( {x}_{N , i + 1} , {y}_{N , i + 1} , {z}_{N , i + 1} , {φ}_{N , i + 1} ) , \\ ( {x}_{N , i + 2} , {y}_{N , i + 2} , {z}_{N , i + 2} , {φ}_{N , i + 2} ) , … , ( {x}_{N , i + M} , {y}_{N , i + M} , {z}_{N , i + M} , {φ}_{N , i + M} ) ,$$

wherein N denotes the number of the predicted trajectory, N∈[1, N3].

In some embodiments, the flight trajectory determination module 150 is configured to: generate an adaptation value for each of the plurality of subsequent flight trajectories based on the total cost model, and generate an optimal subsequent trajectory for the UAVs based on adaptation values for the plurality of subsequent flight trajectories.

The adaptation value is an indicator used to evaluate the merits of different flight trajectories. In some embodiments, the adaptation value may be determined by the processor using the total cost model based on the plurality of subsequent flight trajectories. In some embodiments, the adaptation values of the N subsequent flight trajectories may be expressed as:

$${f}_{1 , 1} , {f}_{2 , 1} , {f}_{3 , 1} , … , {f}_{N , 1} , \\ {f}_{1 , 2} , {f}_{2 , 2} , {f}_{3 , 2} , … , {f}_{N , 2} , \\ {f}_{1 , 3} , {f}_{2 , 3} , {f}_{3 , 3} , … , {f}_{N , 3} , \\ … \\ {f}_{1 , t} , {f}_{2 , t} , {f}_{3 , t} , … , {f}_{N , t} ;$$

wherein f_{N,t} denotes the adaptation values for the subsequent flight trajectories, N denotes a number of a predicted trajectory, N∈[1, N₃]; t denotes a current count of iterations, t∈[1, Tₘₐₓ], and Tₘₐₓ denotes the maximum count of iterations.

The optimal subsequent trajectory refers to a best flight path that the UAVs may follow over a future period.

In some embodiments, the optimal subsequent trajectory may be obtained in a plurality of ways. For example, the processor may define the N3 subsequent flight trajectories as a population of an improved whale optimization algorithm (IWOA), with each subsequent flight trajectory corresponding to an individual in the population, evaluate each individual in the population based on the total cost model, and determine an evaluation result as the adaptation value.

In some embodiments, the processor may determine whether a count of iterations in the above improved whale optimization algorithm is equal to the maximum count of iterations; in response to the count of iterations reaching the maximum count of iterations, the processor may select an individual with a smallest adaptation value as the optimal subsequent trajectory based on adaptation values of individuals of each generation of the population; in response to the count of iterations not reaching the maximum count of iterations, the processor may update each individual using the improved whale optimization algorithm, and select the optimal subsequent trajectory after a set count of optimized generations.

In some embodiments, a process of updating each individual using the improved whale optimization algorithm by the processor includes the following:

### S51, an Initialization Phase:

The processor updates vector coefficients A and C, and a parameter a in the whale optimization algorithm using Equation (14):

$$A = 2 \cdot a \cdot {r}_{1} - a , C = 2 \cdot {r}_{2} , a = 2 - \frac{2 \cdot t}{{T}_{max}} , \qquad ( 14 )$$

wherein r₁ is a random number in (0,1) and a is a number whose value decreases linearly from 2 to 0; r is a random number in (0,1); t denotes the current count of iterations, and Tₘₐₓ denotes the maximum count of iterations.

### S52, a Searching Phase:

If p≤λ, then the whale optimization algorithm enters into the searching phase, wherein p is a random number in (0, 1), λ denotes a set parameter whose value varies with the count of iterations,

$$λ = \frac{t}{{T}_{max}} ,$$

and a classic differential mutation strategy and a random differential mutation strategy are used in the searching phase.

In some embodiments, the classic differential mutation strategy may be represented by Equation (15):

$${X}_{1 , i} ( t + 1 ) = {X}^{*} ( t ) + F \cdot ( {X}_{rand 1} ( t ) - {X}_{rand 2} ( t ) ) , \qquad ( 15 )$$

wherein X*(t) denotes an optimal individual in the population before a generation t, which is an optimal predicted input sequence; X_{rand1}(t) and X_{rand2}(t) denote two different individuals in the generation t, which are two different predicted input sequences, and F is a scaling factor.

The random differential mutation strategy may be expressed by Equation (16):

$${X}_{2 , i} ( t + 1 ) = {r}_{1} \cdot ( {X}^{*} ( t ) - {X}_{i} ( t ) ) + {r}_{2} \cdot ( {X}_{rand 3} ( t ) - {X}_{i} ( t ) ) , \qquad ( 16 )$$

wherein r₁ and r₂ are random numbers in (0,1); X*(t) denotes the optimal individual in the population before the generation t; X_{rand3}(t) denotes an individual in the generation t, which is a random predicted input sequence; and Xᵢ(t) denotes an i^{th} individual in the generation t, which is an i^{th} predicted input sequence.

The above two strategies are selected based on Equation (17):

$${X}_{i} ( t + 1 ) = \{ \begin{matrix}{X}_{1 , i} ( t + 1 ) & rand \leq CR or j = {j}_{rand} & j = 1 , 2 , … , N \\ {X}_{2 , i} ( t + 1 ) & otherwise & \end{matrix} , \qquad ( 17 )$$

wherein Xᵢ(t+1) denotes an i^{th} individual in a generation (t+1), which is the i^{th} predicted input sequence; j_{rand} is a randomly generated integer between 1 and N, and CR denotes a randomly generated crossover probability between 0 and 1.

### S53, an Encircling Prey Phase:

If p<λ, then the whale optimization algorithm enters into the encircling prey phase, and the processor may use an encircling-and-surrounding prey strategy and a spiral-update prey strategy in the encircling prey phase.

In some embodiments, the encircling-and-surrounding prey strategy may be represented by Equation (18):

$${X}_{3 , i} ( t + 1 ) = ω \cdot {X}^{*} ( t ) - A \cdot D , \qquad ( 18 )$$

The spiral-update prey strategy may be expressed by Equation (19):

$${X}_{4 , i} ( t + 1 ) = ω \cdot {X}^{*} ( t ) + D \cdot {e}^{bl} \cdot cos ( 2 π l ) , \qquad ( 19 )$$

The above two strategies are selected based on Equation (20):

$${X}_{i} ( t + 1 ) = \{ \begin{matrix}{X}_{3 , i} ( t + 1 ) & q \leq 0.5 \\ {X}_{4 , i} ( t + 1 ) & q > 0.5\end{matrix} {X}_{i} ( t + 1 ) = \{ \begin{matrix}{X}_{3 , i} ( t + 1 ) & q \leq 0.5 \\ {X}_{4 , i} ( t + 1 ) & q > 0.5\end{matrix} , \qquad ( 20 )$$

wherein ω denotes a second weight coefficient determined adaptively; D denotes a distance between a current individual and the optimal individual, which is a distance between a current predicted trajectory and a trajectory corresponding to the optimal individual; b denotes a spiral shape parameter; l denotes a cycle parameter, whose value is a random number in (−1,1); and q denotes a probability of randomly selecting a predation mode. X*(t) denotes the optimal individual in the population before the generation t, and Xᵢ(t) denotes the i^{th} individual in the generation t, which is the i^{th} predicted input sequence.

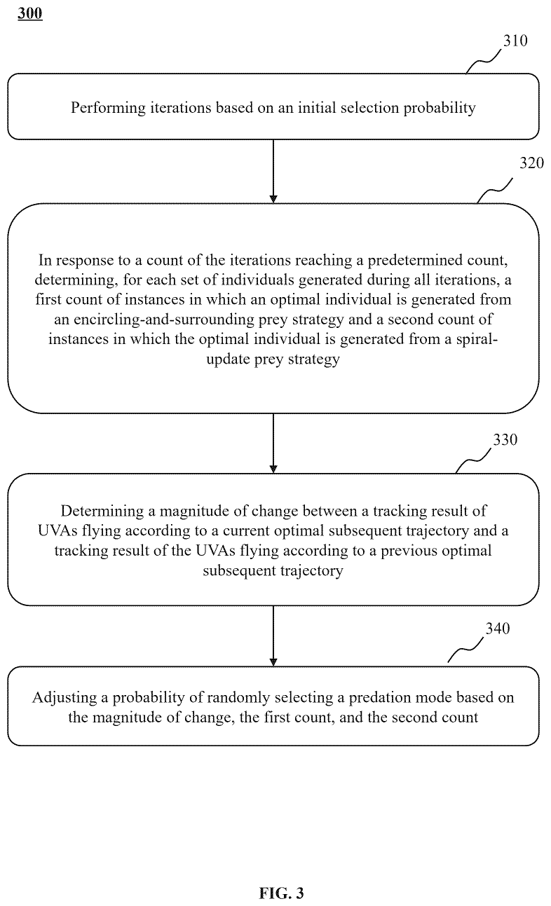

In some embodiments, the processor may adjust the probability of randomly selecting a predation mode. More details regarding adjusting the probability of randomly selecting a predation mode may be found in other contents of the present disclosure (e.g., description in connection with FIG. 3).

In some embodiments, in S53 above, the second weight coefficient @ may be represented by Equation (21):

$$ω = 1 - \frac{{e}^{\frac{t}{{T}_{max}}} - 1}{e - 1} , \qquad ( 21 )$$

In some embodiments, the processor determines a predicted remaining energy level based on a current energy level and a predicted energy consumption amount, and adjusts the second weight coefficient ω based on the predicted remaining energy level.

The current energy level refers to current remaining energy (e.g., remaining power) of the UAVs.

The predicted energy consumption amount refers to an anticipated amount of energy consumption of the UAVs in a future period, e.g., consuming 12% of the battery life, etc.

In some embodiments, the processor may determine the predicted energy consumption amount in a plurality of ways (e.g., statistical analysis, look-up tables, modeling, etc.). For example, the processor may generate the predicted energy consumption amount through a UAV energy consumption model.

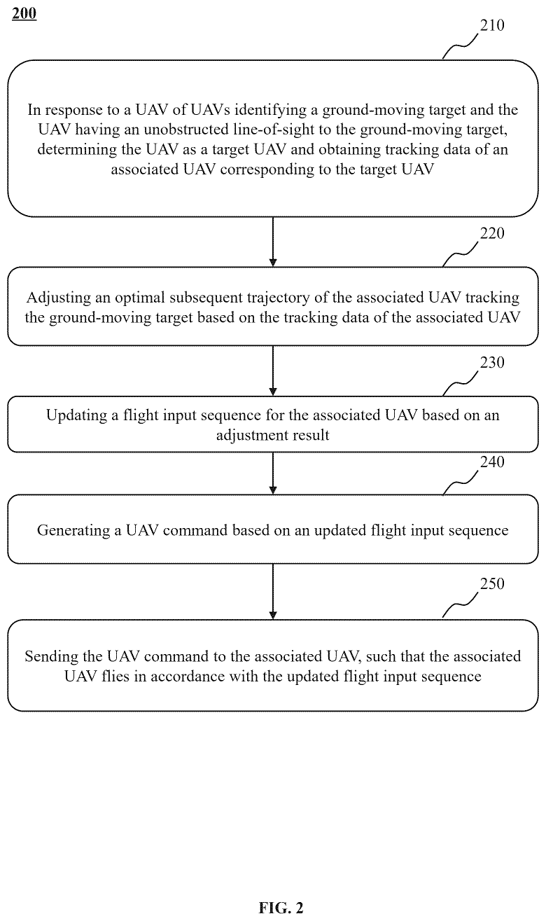

More details regarding the UAV energy consumption model may be found in other contents of the present disclosure (e.g., description in connection with FIG. 2).

The predicted remaining energy level refers to an estimated remaining energy level (e.g., remaining power) of the UAVs at a future time point. In some embodiments, the processor may generate the predicted remaining energy level by subtracting the predicted energy consumption amount from the current energy level of the UAVs.

In some embodiments, the processor may adjust the second weight coefficient @ based on the predicted remaining energy level in a plurality of ways (e.g., looking up a table, searching a database, using a predetermined algorithm, etc.).

For example, the processor may multiply a pre-adjusted second weight coefficient by the predicted remaining energy level to generate an adjusted second weight coefficient.

It should be noted that, if the current energy level of the UAVs is relatively low, a relatively large flight trajectory adjustment may cause an insufficient endurance issue for the UAVs. In some embodiments of the present disclosure, the processor adjusts the second weight coefficient @ according to the magnitude of the predicted remaining energy level, so that when the predicted remaining energy level of the UAVs is low, the processor does not tend to make a relatively large adjustment to the flight trajectory of the UAVs, thereby effectively avoiding excessive energy consumption by the UAVs.

### S54, an Offspring Update Phase:

The processor selects the optimal individual as an offspring individual using an elite selection strategy.

In some embodiments, the elite selection strategy may be represented by Equation (22):

$${X}_{i} ( t + 1 ) = \{ \begin{matrix}{X}_{i} ( t ) & f ( {X}_{l , i} ( t + 1 ) ) > f ( {X}_{i} ( t ) ) \\ {X}_{i} ( t + 1 ) & else\end{matrix} , \qquad ( 22 )$$

wherein Xᵢ(t) denotes the i^{th} individual in the generation, which is the i^{th} predicted input sequence, and Xᵢ(t+1) denotes the i^{th} individual in generation (t+1), which is the (i+1)^{th} predicted input sequence.

In some embodiments, the flight trajectory control module 160 is configured to: send a flight input sequence corresponding to the optimal subsequent trajectory to a corresponding UAV via a mobile network.

In some embodiments, the flight trajectory control module 160 may transform the optimal subsequent trajectory determined through the above operations to the subsequent control sequences corresponding to the UAVs based on the second dynamic model, a first item of each of the subsequent control sequences being a next flight control input of a corresponding UAV. The flight trajectory control module 160 may repeat the operations executed by the UAV parameter generation module 130, the flight trajectory prediction module 140, and the flight trajectory determination module 150 until obtaining flight input sequences during the entire tracking process of the ground-moving target, and obtain the optimal trajectory for the multi-UAV cooperative tracking the ground-moving target. It may be understood that repeating the operations executed by the UAV parameter generation module 130, the flight trajectory prediction module 140, and the flight trajectory determination module 150 is a process in which the UAVs determine the subsequent control sequences multiple times throughout the tracking process.

In some embodiments of the present disclosure, the processor combines model predictive control with the improved whale optimization algorithm, using the model predictive control approach as a solver for the UAVs' tracking of the ground-moving target, and the whale optimization algorithm as an optimizer for the model prediction, to enhance the algorithm's convergence speed and precision, thereby further improving the accuracy and stability of tracking the ground-moving target. In the improved whale optimization algorithm, the processor introduces the guidance function in the random initialization phase of the population, which guides the UAVs in selecting the input control variables based on the current status information of the UAVs and the ground-moving target, as well as the angle between the flight direction of the UAVs and the moving direction of the ground-moving target, thereby improving the stability of tracking the ground-moving target and increasing tracking accuracy. The processor uses the classic differential mutation strategy and the random differential mutation strategy during the searching phase to enhance the diversity of the population, compensating for the reduced global search capability of the algorithm caused by the preference for selection in the initial phase, and timely escaping the local optima caused by premature convergence in the later phases of the algorithm. The processor employs an adaptive weight strategy and the elite selection strategy in the encircling prey phase and the offspring update phase. As the count of iterations increases, the adaptive parameters of the optimal individuals in the population gradually decreases, enhancing the local optimization capability of the algorithm. During the offspring update phase, the elite selection strategy can be used to select optimal individuals to enter the next generation, thus improving the convergence speed and accuracy of the algorithm.

It should be understood that the system and its modules shown in FIG. 1 may be realized using a plurality of ways. It is to be noted that the above descriptions of the system for controlling multi-UAV cooperative tracking of the ground-moving target and the modules thereof are only for the convenience of description, and do not limit the present disclosure to the scope of the embodiments cited.

FIG. 2 is a flowchart illustrating an exemplary process for updating a flight control sequence of an associated UAV according to some embodiments of the present disclosure. As shown in FIG. 2, process 200 may include the following operations. In some embodiments, process 200 may be executed by a processor.

In 210, in response to a UAV of UAVs identifying a ground-moving target and the UAV having an unobstructed line-of-sight to the ground-moving target, the UAV may be determined as a target UAV, and tracking data of the associated UAV corresponding to the target UAV may be obtained.

The target UAV refers to a UAV that currently recognizes the ground-moving target and has an unobstructed line-of-sight.

The unobstructed line-of-sight of the target UAV to the ground-moving target refers to that a monitoring range of the UAV is not obstructed by obstacles, so that the UAV consistently recognizes the ground-moving target.

In some embodiments, in response to the target UAV being unable to recognize the ground-moving target for a subsequent preset period after the target UAV initially recognizes the ground-moving target, the processor determines that the target UAV has an obstructed line-of-sight to the ground-moving target.

In some embodiments, the processor may determine, in a plurality of ways, whether the UAV recognizes the ground-moving target.

For example, the processor may determine, based on an image captured by the UAV, whether the ground-moving target appears in the image, and thus determine whether the UAV recognizes the ground-moving target. The UAV may capture images in a specified direction (e.g., a moving direction of the ground-moving target) at a preset shooting frequency, and the UAV may acquire a plurality of consecutive images at each shooting.

In some embodiments, a length of the subsequent preset period may include a preset count of time steps. A time step refers to an interval (e.g., 0.5 s) between sampling times at which the UAV collects relevant parameters (e.g., a position, a flight velocity, a flight angle, etc., of the UAV).

In some embodiments, the processor may determine the length of the subsequent preset period based on at least one of the flight velocity of the UAV, a moving velocity of the ground-moving target, and the shooting frequency of the UAV. For example, the slower the flight velocity of the UAV, and the higher the shooting frequency, the lower a likelihood that the UAV fails to recognize the ground-moving target, thus the longer the length of the subsequent preset period may be.

In some embodiments, the processor may determine the length of the subsequent preset period in a plurality of ways. For example, the length of the preset time period may be determined by the processor by looking up a timetable.

In some embodiments, the timetable may be constructed based on historical tracking data of the UAVs stored in the processor. For example, the processor may count, based on the historical tracking data of a UAV, a plurality of time lengths in which the UAV is unable to recognize the ground-moving target at a certain flight velocity and a certain shooting frequency. The processor may determine a minimum value of the plurality of time lengths as the length of the subsequent preset period that corresponds to the flight velocity and the shooting frequency of the UAV.

The associated UAV refers to a UAV whose distance from the target UAV satisfies a second predetermined condition. Satisfying the second predetermined condition may include: the distance from the associated UAV to the target UAV being less than a preset distance.

The preset distance may be a distance threshold preset by the processor. For example, the preset distance may be equal to a sum of a minimum safe distance between the UAVs and a buffer distance between the UAVs.

More details regarding the tracking data, the minimum safe distance between the UAVs, and the buffer distance between the UAVs may be found in other contents of the present disclosure (e.g., description in connection with FIG. 1).

In 220, an optimal subsequent trajectory of the associated UAV tracking the ground-moving target may be adjusted based on the tracking data of the associated UAV.

More details regarding the optimal subsequent trajectory may be found in other contents of the present disclosure (e.g., description in connection with FIG. 1).

In some embodiments, the processor may adjust the optimal subsequent trajectory of the associated UAV in a plurality of ways (e.g., retrieving databases, statistical analysis, etc.). For example, the processor may pre-generate a plurality of candidate adjusted trajectories, and filter out, from the plurality of candidate adjusted trajectories, the adjusted optimal subsequent trajectory of the associated UAV that fulfills requirements.

The candidate adjusted trajectories refer to adjusted trajectories of the associated UAV pre-generated by the processor.

In some embodiments, the processor may randomly generate the plurality of candidate adjusted trajectories by a random number generation algorithm (e.g., a rand function, a linear congruence generator, etc.). For example, the processor may randomly adjust x, y, z, and φ in the optimal subsequent trajectory of the associated UAV, as determined in a previous iteration, using the random number generation algorithm, and determine the adjusted trajectories as the candidate adjusted trajectories.

In some embodiments, the processor may preset a plurality of constraints, and randomly generate the plurality of candidate adjusted trajectories under the constraints. The constraints may include the minimum safe distance between the UAVs, the buffer distance between the UAVs, a minimum distance between the UAVs and a nearest obstacle, or the like.

In some embodiments, for a candidate adjusted trajectory, the processor determines a predicted energy consumption amount of the associated UAV using a UAV energy consumption model based on an initial optimal subsequent trajectory of the associated UAV, the candidate adjusted trajectory, wind force and direction data, flight altitude data of the associated UAV, and a current energy level of the associated UAV. The initial optimal subsequent trajectory refers to the optimal subsequent trajectory determined in the previous iteration.

In some embodiments, the UAV energy consumption model may be a neural networks (NN) model.

In some embodiments, an input of the UAV energy consumption model may include the initial optimal subsequent trajectory, the candidate adjusted trajectory, the wind force and direction data, the flight altitude data, and the current energy level, and an output of the UAV energy consumption model may include the predicted energy consumption amount.

The wind force and direction data refers to data of a strength and a direction of the wind at the location of the UAV. In some embodiments, the wind force and direction data may be obtained by monitoring using a sensor configured on the UAV.

The flight altitude data refers to a flight altitude of the UAV.

More details regarding the current energy level and the predicted energy consumption amount may be found in other contents of the present disclosure (e.g., description in connection with FIG. 1).

In some embodiments, the UAV energy consumption model may be obtained by the processor through training.

In some embodiments, the processor may be configured to obtain a plurality of training samples and labels. Each training sample may include a sample initial optimal subsequent trajectory, a sample candidate adjusted trajectory, sample wind force and direction data, sample flight altitude data of a sample UAV, and a sample current energy level of the sample UAV. The label of a training sample may include a sample predicted energy consumption amount of the sample UAV corresponding to the training sample. The processor may be configured to: set a plurality of training sets and a learning rate corresponding to each of the plurality of training sets based on at least one of the sample current energy level and a trajectory complexity of sample UAVs, train an initial UAV energy consumption model based on the learning rate of the each of the plurality of training sets, the plurality of training samples, and the labels, and acquire the UAV energy consumption model until a trained UAV energy consumption model satisfies a first predetermined condition. The sample initial optimal subsequent trajectory refers to a sample optimal subsequent trajectory determined in a previous iteration for the sample UAV. The first predetermined condition may include convergence of a loss function, a count of iterations reaching a threshold, or the like.

The trajectory complexity of a sample UAV refers to a complexity of a flight trajectory of the sample UAV. For example, the greater the frequency and magnitude of a change in the flight angle of the sample UAV is, the greater the trajectory complexity of the sample UAV is.

In some embodiments, the processor may determine the trajectory complexity based on a standard deviation of the angle between the UAV's flight direction at each time step and a previous time step over a plurality of consecutive time steps.

In some embodiments, the processor may divide the training samples into a plurality of training sets based on at least one of the sample current energy level and the trajectory complexity. For example, the processor may divide training samples with sample current energy levels in arrange of 90%-100% into a training set 1, and training samples with sample current energy levels in a range of 80%-90% into a training set 2, etc.

In some embodiments, the processor may set different learning rates based on the sample current energy levels and the trajectory complexities of different training samples.

For example, when parameters of the UAV energy consumption model are initialized or starting to train the UAV energy consumption model, the processor may train the UAV energy consumption model based on a training set with a relatively high sample current energy level (e.g., the sample current energy level is in a range of 75%-100%) or a low trajectory complexity, and automatically set a relatively large learning rate. As the training process advances, the processor may progressively train the UAV energy consumption model using training sets with a relative low sample current energy level (e.g., the sample current energy level is less than 75%) and progressively decrease the learning rate.

In some embodiments of the present disclosure, the processor dynamically adjusts the training process of the UAV energy consumption model, including adjusting the order in which the training sets are used, the learning rate, etc., based on at least one of the sample current energy level of the sample UAV and the trajectory complexity of the sample UAV. In this way, the quality and efficiency of the model training can be improved, and the reliability of output results of the model can be enhanced.

In some embodiments, the processor may select a candidate adjusted trajectory from different candidate adjusted trajectories corresponding to predicted energy consumption amounts output from the UAV energy consumption model, wherein the candidate adjusted trajectory corresponds to a smallest predicted energy consumption amount and a smallest sum of distances between associated UAVs and the ground-moving target. The processor may determine the selected candidate adjusted trajectory as the adjusted optimal subsequent trajectory of the associated UAVs. The sum of the distances refers to a sum of the distance between each of the associated UAVs and the ground-moving target.

In some embodiments, the processor may perform a weighted summation on the predicted energy consumption amounts and the sum of the distances, and select the candidate adjusted trajectory corresponding to a smallest weighted sum as the adjusted optimal subsequent trajectory of the associated UAV. Weight coefficients used for the weighted summation may be values preset by the processor.

In 230, a flight input sequence for the associated UAV may be updated based on an adjustment result.

In some embodiments, the processor may regenerate the flight input sequence for the associated UAV based on the adjusted optimal subsequent trajectory of the associated UAV. More details regarding the flight input sequence may be found in other contents of the present disclosure (e.g., description in connection with FIG. 1).

In 240, a UAV command may be generated based on an updated flight input sequence.

In some embodiments, the processor may regenerate the UAV command based on the updated flight input sequence, the regenerated UAV command including the updated flight input sequence.

In 250, the UAV command may be sent to the associated UAV, such that the associated UAV flies in accordance with the updated flight input sequence.

In some embodiments, the processor may send corresponding UAV commands to different associated UAVs separately.

In some embodiments of the present disclosure, the processor, by determining the associated UAV of the target UAV and regulating the flight parameters of the associated UAV within a reasonable range, enables the UAVs to assist and substitute for each other promptly during tracking, so that the UAVs can track the ground-moving target more effectively.

FIG. 3 is s flowchart illustrating an exemplary process for adjusting a probability of randomly selecting a predation mode according to some embodiments of the present disclosure. As shown in FIG. 3, process 300 may include the following operations. In some embodiments, the process 300 may be executed by a processor.

In 310, iterations may be performed based on an initial selection probability.

The initial selection probability refers to a selection probability that is preset by the processor for selecting different predation modes randomly. For example, the initial selection probability is set to 0.5. The randomly selected predation modes refer to approaches of generating the next generation of individuals, which may include an encircling-and-surrounding prey strategy and a spiral-update prey strategy.

More details regarding the iterations may be found in other contents of the present disclosure (e.g., description in connection with FIG. 1).

In 320, in response to a count of iterations reaching a predetermined count, for each set of individuals generated during all iterations, a first count of instances in which an optimal individual is generated from the encircling-and-surrounding prey strategy and a second count of instances in which the optimal individual is generated from the spiral-update prey strategy may be determined

The predetermined count refers to a count of iterations predefined by the processor.

The first count refers to a count of instances, across all the iterations, in which the optimal individual in each iteration is generated by the encircling-and-surrounding prey strategy. The second count refers to a count of instances, across all the iterations, in which the optimal individual in each iteration is generated by the spiral-update prey strategy.

In 330, a magnitude of change between a tracking result of the UAVs flying according to a current optimal subsequent trajectory and a tracking result of the UAVs flying according to a previous optimal subsequent trajectory may be determined.

The tracking result refers to information generated from the statistics of tracking data. For example, the tracking result may include a count of the UAVs that identify a ground-moving target and an identification duration. The identification duration refers to a cumulative duration during which the UAVs identify the ground-moving target. For example, the identification duration may be a sum of the durations of a plurality of instances in which the UAVs identify the ground-moving target. In some embodiments, the processor may generate an average identification duration based on an average of the identification durations of a plurality of UAVs.

More details regarding the tracking data may be found in other contents of the present disclosure (e.g., description in connection with FIG. 1).

The magnitude of change may include a magnitude of change in the count of the UAVs identifying the ground-moving target at different time points, and a magnitude of change in the identification duration.

In some embodiments, the magnitude of change may be an average of the magnitude of change in the count of the UAVs identifying the ground-moving target and the magnitude of change in the identification duration.

In 340, the probability of randomly selecting a predation mode may be adjusted based on the magnitude of change, the first count, and the second count.

In some embodiments, the processor may adjust the probability of randomly selecting a predation mode in a plurality of ways (looking up a table, statistical generalization, etc.).

For example, the processor may determine an adjusted probability of randomly selecting a predation mode by using Equation (23):

$${q}_{r} = 0.5 \times B + \frac{{Q}_{1} - {Q}_{2}}{{Q}_{1} + {Q}_{2}} , \qquad ( 23 )$$

wherein qᵣ denotes the updated probability of randomly selecting a predation mode, B denotes the magnitude of change, Q₁ denotes the first count, and Q₂ denotes the second count.

In some embodiments of the present disclosure, the processor, by dynamically adjusting the probability of randomly selecting a predation mode, can make the subsequently generated next-generation individuals more likely to approach to the optimal next-generation individuals, thereby improving iterative efficiency. Furthermore, by combining the historical tracking result and performance from UAVs tracking moving ground targets, the processor can adjust the probability of randomly selecting a predation mode in reverse, further improving the tracking performance of the subsequent flight trajectories.

The method for controlling multi-UAV cooperative tracking a ground-moving target will be described in detail below by Example 1. It should be noted that models, optimization algorithms, etc., in Example 1 are only intended to illustrate the method for controlling multi-UAV cooperative tracking a ground-moving target, and do not limit the scope of protection of the present application.

### Example 1

The following provides an example to further illustrate the method for controlling multi-UAV cooperative tracking a ground-moving target provided in the embodiments of the present disclosure provide. The method includes:
S1, an urban topography is designated as a flight environment for multi-UAV target tracking, and a 3D coordinate map for the target tracking, obstacle information, a first dynamic model, a second dynamic model, and a total cost model for target tracking control may be constructed based on the flight environment and a flight area. The first dynamic model may also be referred to as a moving target motion model, and the second dynamic model may also be referred to as a UAV dynamic model.

In this example, boundary conditions of the flight environment may be set as follows:
0≤X≤2000 m, 0≤Y≤2000 m, 0≤H≤200 m,
   wherein X denotes a flight range in an X-axis direction of a ground area, Y denotes a flight range in a Y-axis direction of the ground area, and H denotes a flight altitude.

In this example, starting positions (starting coordinates) of the UAVs may be set as follows: (15, 1575, 100), (25, 1620, 100), and (40, 1580, 100), respectively, and a starting coordinate of the ground-moving target is (20, 1600, 0).

Given that the task is to track the ground-moving target, to ensure that the ground-moving target can be tracked accurately and in a timely manner, the processor sets first weight coefficients of a target coverage cost and a horizontal distance cost to be greater than first weight coefficients of other costs. The first weight coefficients are detailed in the following Table 1.

TABLE 1

| Hori- | | | | Communi- | Energy |
|---|---|---|---|---|---|
| zontal | Obstacle | Target | Safety | cation | consump- |
| distance | avoidance | coverage | distance | distance | tion |
| cost | cost | cost | cost | cost | cost |
| m₁ | m₂ | m₃ | m₄ | m₅ | m₆ |
| 0.25 | 0.125 | 0.375 | 0.125 | 0.125 | 0.125 |

S2, an input constraint and a guidance function for an input control variable of the UAVs may be set based on the models constructed in S1, and N₃ subsequent control sequences may be randomly generated based on the input constraint and the guidance function of the input control variable, while satisfying a performance constraint of the UAVs. The input constraint may also be referred to as a constraint, and the performance constraint may also be referred to as an airframe performance constraint.

In this embodiment, the processor may set the input constraint for the UAVs as follows:

22 m/s≤νᵢ≤32 m/s, −0.25 rad/s≤ωᵢ≤0.25 rad/s

In this example, a sampling time for the target tracking is T=0.5 s, and a total tracking time is Tₜₒₗ=155 s. A count of predicted subsequent flight trajectories is set to N3=30, and a predicted count of steps of the subsequent trajectories of the UAVs is set to M=8, and initial trajectories are sequentially numbered as: 1, 2, 3 . . . 30.

Based on the input constraint and the guidance function, the processor randomly generates 30 subsequent control sequences as follows:

$$( {v}_{1 , 2} , {ω}_{1 , i} ) , ( {v}_{l , i + 1} , {ω}_{l , i + 1} ) , ( {v}_{l , i + 2} , {ω}_{l , i + 2} ) , … , ( {v}_{1 , i + M} , {ω}_{1 , i + M} ) , \\ ( {v}_{2 , i} , {ω}_{2 , i} ) , ( {v}_{2 , i + 1} , {ω}_{2 , i + 1} ) , ( {v}_{2 , i + 2} , {ω}_{2 , i + 2} ) , … , ( {v}_{2 , i + M} , {ω}_{2 , i + M} ) , \\ ( {v}_{3 , i} , {ω}_{3 , i} ) , ( {v}_{2 , i + 1} , {ω}_{2 , i + 1} ) , ( {v}_{3 , i + 2} , {ω}_{3 , i + 2} ) , … , ( {v}_{3 , i + M} , {ω}_{3 , i + M} ) , \\ … \\ ( {v}_{30 , i} , {ω}_{30 , i} ) , ( {v}_{30 , i + 1} , {ω}_{30 , i + 1} ) , ( {v}_{30 , i + 2} , {ω}_{30 , i + 2} ) , … , ( {v}_{30 , i + M} , {ω}_{30 , i + M} )$$

S3, 30 subsequent flight trajectories may be predicted using the 30 subsequent control sequences obtained in S2 based on current status information of the UAVs and the second dynamic model constructed in S1. The subsequent flight trajectories may also be referred to as subsequent UAV flight trajectories.

The processor predicts the 30 subsequent flight trajectories as:

$$( {x}_{1 , i} , {y}_{1 , i} , {z}_{1 , i} , {φ}_{1 , i} ) , ( {x}_{1 , i + 1} , {y}_{1 , i + 1} , {z}_{1 , i + 1} , {φ}_{1 , i + 1} ) , \\ ( {x}_{1 , i + 2} , {y}_{1 , i + 2} , {z}_{1 , i + 2} , {φ}_{1 , i + 2} ) , … , ( {x}_{1 , i + M} , {y}_{1 , i + M} , {z}_{1 , i + M} , {φ}_{1 , i + M} ) , \\ ( {x}_{2 , i} , {y}_{2 , i} , {z}_{2 , i} , {φ}_{2 , i} ) , ( {x}_{2 , i + 1} , {y}_{2 , i + 1} , {z}_{2 , i + 1} , {φ}_{2 , i + 1} ) , \\ ( {x}_{2 , i + 2} , {y}_{2 , i + 2} , {z}_{2 , i + 2} , {φ}_{2 , i + 2} ) , … , ( {x}_{2 , i + M} , {y}_{2 , i + M} , {z}_{2 , i + M} , {φ}_{2 , i + M} ) , \\ ( {x}_{3 , i} , {y}_{3 , i} , {z}_{3 , i} , {φ}_{3 , i} ) , ( {x}_{3 , i + 1} , {y}_{3 , i + 1} , {z}_{3 , i + 1} , {φ}_{3 , i + 1} ) , \\ ( {x}_{3 , i + 2} , {y}_{3 , i + 2} , {z}_{3 , i + 2} , {φ}_{3 , i + 2} ) , … , ( {x}_{3 , i + M} , {y}_{3 , i + M} , {z}_{3 , i + M} , {φ}_{3 , i + M} ) , \\ … \\ ( {x}_{30 , i} , {y}_{30 , i} , {z}_{30 , i} , {φ}_{30 , i} ) , ( {x}_{30 , i + 1} , {y}_{30 , i + 1} , {z}_{30 , i + 1} , {φ}_{30 , i + 1} ) , \\ ( {x}_{30 , i + 2} , {y}_{30 , i + 2} , {z}_{30 , i + 2} , {φ}_{30 , i + 2} ) , … , ( {x}_{30 , i + M} , {y}_{30 , i + M} , {z}_{30 , i + M} , {φ}_{30 , i + M} )$$

S4, a population of an improved whale optimization algorithm (IWOA) may be defined based on the 30 subsequent flight trajectories obtained in S3, wherein each subsequent flight trajectory corresponds to an individual in the population. Each individual in the population may be evaluated based on the total cost model for target tracking control constructed in S1, and an evaluation result may be determined as an adaptation value.

The adaptation value of the predicted trajectory is represented as:

$${f}_{1 , 1} , {f}_{2 , 1} , {f}_{3 , 1} , … , {f}_{30 , 1} , \\ {f}_{1 , 2} , {f}_{2 , 2} , {f}_{3 , 2} , … , {f}_{30 , 2} , \\ {f}_{1 , 3} , {f}_{2 , 3} , {f}_{3 , 3} , … , {f}_{30 , 3} , \\ … \\ {f}_{1 , t} , {f}_{2 , t} , {f}_{3 , t} , … , {f}_{30 , t}$$

wherein f_{N,t} denotes the adaptation values for the subsequent flight trajectories, N denotes the number of the predicted trajectory, N=30; t denotes the count of iterations, t∈[1, 100], and a maximum count of iterations is 100.
S5, before using the improved whale optimization algorithm to optimize the predicted subsequent trajectory, whether the count of iterations in the improved whale optimization algorithm in S4 is equal to the maximum count of iterations is determined. The maximum count of iterations in the example is set to 100. In response to the count of iterations reaching the maximum count of iterations, the individual with a smallest adaptation value is selected as an optimal subsequent trajectory based on the adaptation values of individuals of each generation of the population obtained in S4. In response to the count of iterations not reaching the maximum count of iterations, each individual is updated using the improved whale optimization algorithm to select the optimal subsequent trajectory after a set count of optimized generations. The optimal subsequent trajectory may also be referred to as an optimal predicted subsequent trajectory.
S6, the optimal subsequent trajectory selected in S5 is transformed to the subsequent control sequences corresponding to the UAVs, based on the second dynamic model constructed in S1. A first item of each of the subsequent control sequences is a next flight input of a corresponding UAV. The operations S2 to S6 are repeated until flight input sequences during the entire tracking process of the target are obtained, and the optimal trajectory for the multi-UAV cooperative tracking of the ground-moving target is finally obtained. The flight input sequence may also be referred to as a flight input control variable sequence.

It should be noted that operation S1 is performed by the terrain building module 110 and the flight simulation module 120, the operation S2 is performed by the UAV parameter generation module 130, the operation S3 is performed by the flight trajectory prediction module 140, and the operations S4 to S6 are performed by the flight trajectory determination module 150.

More details regarding the obstacle information, the first dynamic model, the second dynamic model, the total cost model, the guidance function, and the process of updating each individual using the improved whale optimization algorithm may be found in other contents of the present disclosure (e.g., description in connection with FIG. 1).

The MPC+IWOA approach of the method provided in the present disclosure and the MPC+GWO approach of the existing method in the prior art are comparatively analyzed as follows.

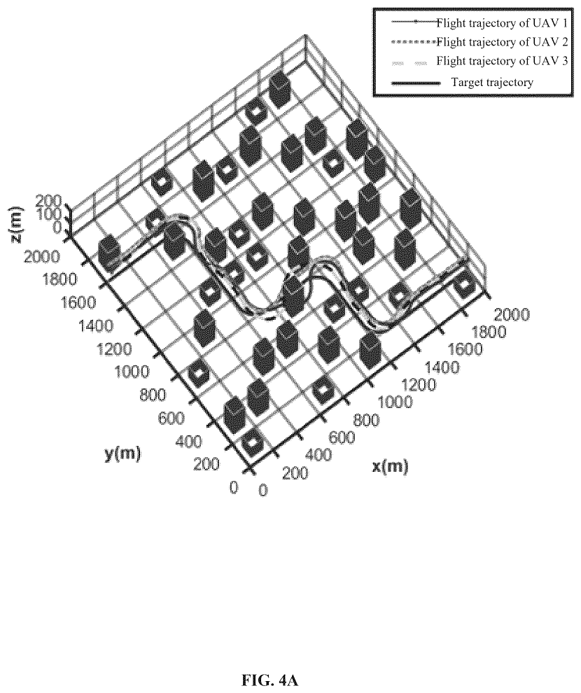

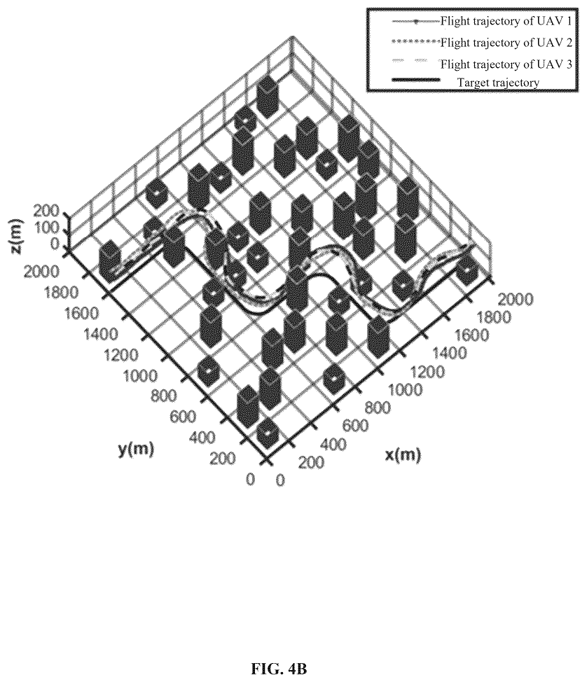

FIG. 4A is a schematic diagram illustrating trajectories of UAVs tracking a ground-moving target, obtained using an MPC+IWOA approach according to some embodiments of the present disclosure. As shown in FIG. 4A, all the three UAVs are capable of tracking the ground-moving target and avoiding obstacles. FIG. 4B is a schematic diagram illustrating trajectories of UAVs tracking a ground-moving target, obtained using an MPC+Grey Wolf Optimization (GWO) approach according to some embodiments of the present disclosure. As shown in FIG. 4B, a first UAV collides with a building. Therefore, in terms of obstacle avoidance, the method provided in the present disclosure is superior to the existing method.

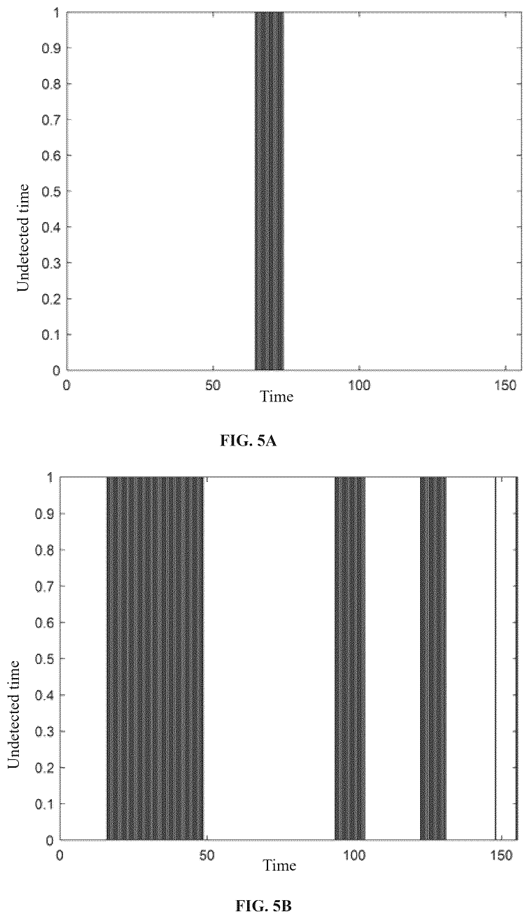

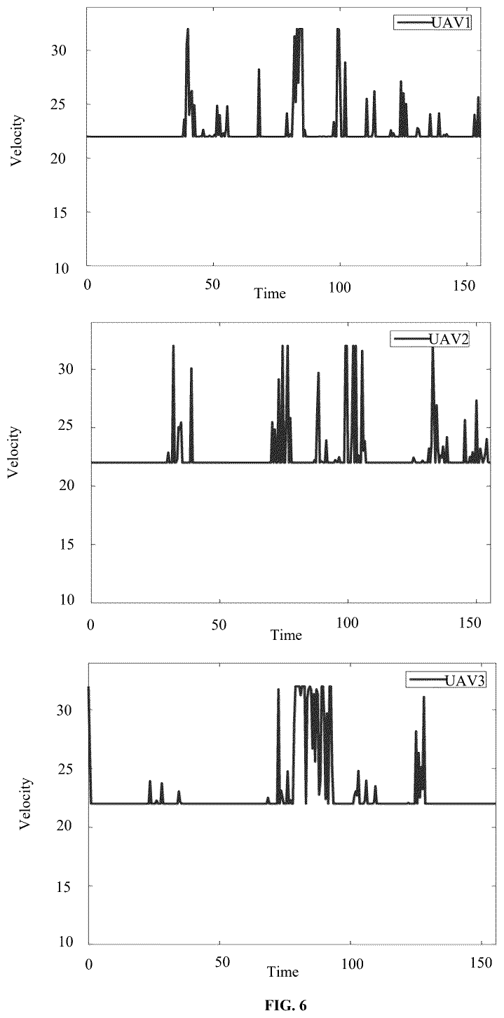

FIG. 5A is a time graph illustrating a failure to track a ground-moving target using an MPC+IWOA approach according to some embodiments of the present disclosure. The total time of target tracking is 155 s, and the total time the ground-moving target is detected is 146 s. FIG. 5B is a time graph illustrating a failure to track a ground-moving target using an MPC+GWO approach according to some embodiments of the present disclosure. The total time the ground-moving target is detected is only 103 s. Therefore, the tracking performance of the method provided by the present disclosure is better than the existing method because the improved whale optimization algorithm (IWOA) outperforms the existing method in search capability and convergence accuracy.

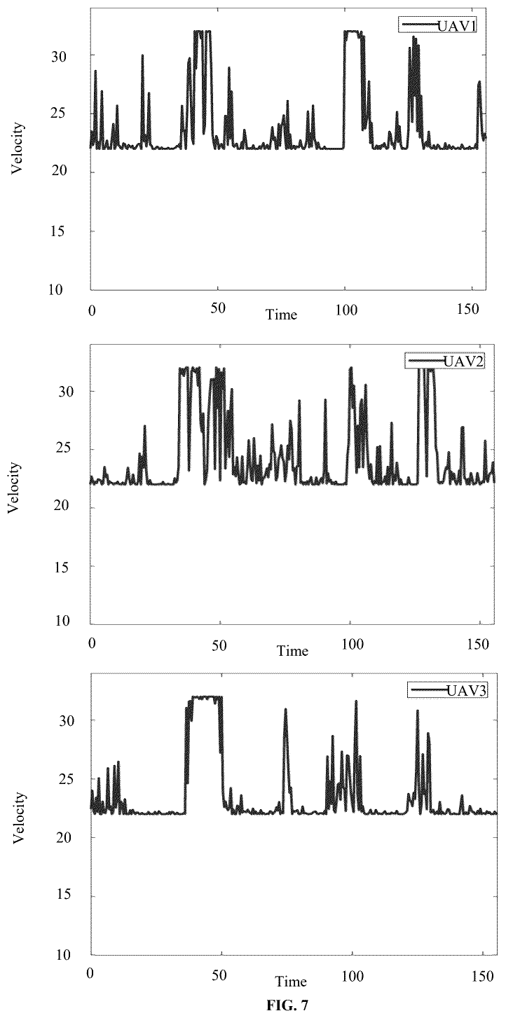

FIG. 6 shows velocity changes of UAVs during a tracking process using an MPC+IWOA approach according to some embodiments of the present disclosure. FIG. 7 shows velocity changes of UAVs during a tracking process using an MPC+GWO approach according to some embodiments of the present disclosure. As may be seen from the FIGS. 6 and 7, the velocity of the UAVs changes more frequently when the MPC+GWO approach is used to track the target, while the velocity of the UAVs is more stable using the method of the present disclosure. This indicates that the method of the present disclosure offers better stability in target tracking compared to the existing method.

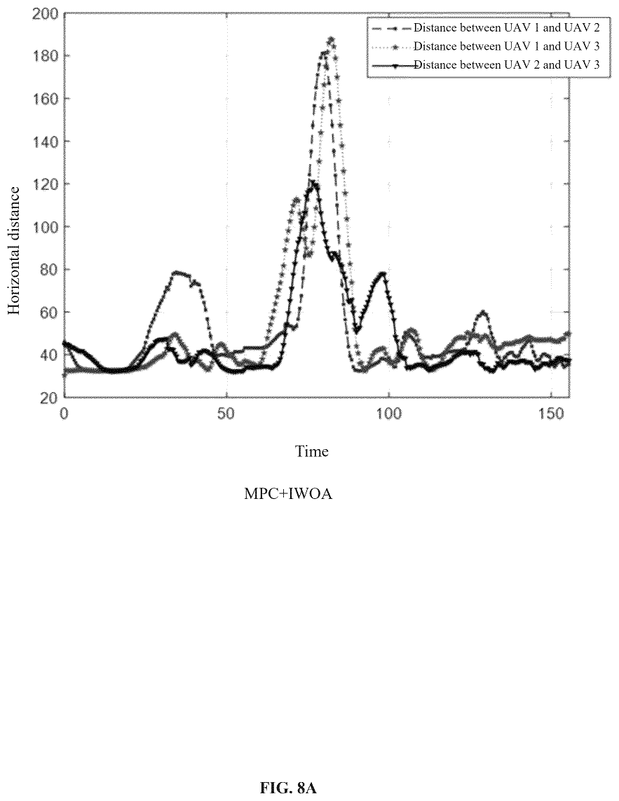

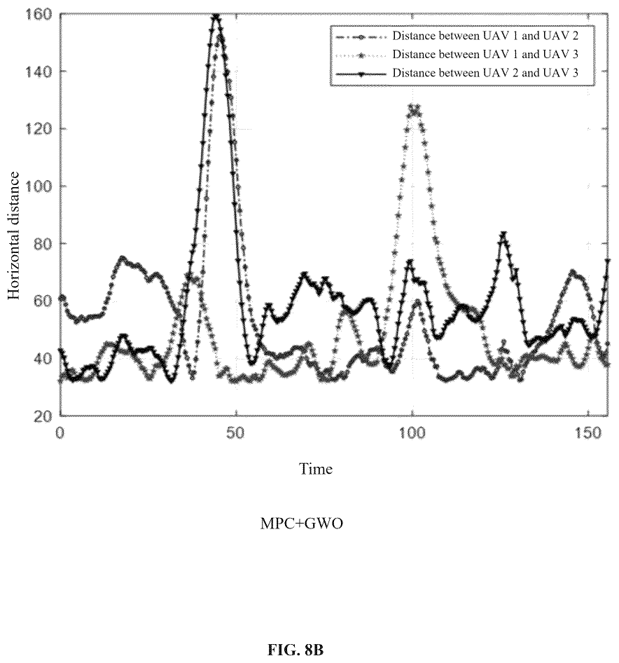

FIG. 8A is a diagram illustrating a result of flight distances between UAVs, obtained using an MPC+IWOA approach according to some embodiments of the present disclosure. FIG. 8B is a diagram illustrating a result of flight distances between UAVs, obtained using an MPC+GWO approach according to some embodiments of the present disclosure. As may be seen, the two tracking approaches satisfy the spatial constraints.

The basic concepts are described above. Obviously, for those skilled in the art, the above detailed disclosure is only an example, and does not constitute a limitation to the present disclosure. Although not expressly stated here, those skilled in the art may make various modifications, improvements, and corrections to the present disclosure. Such modifications, improvements and corrections are suggested in present disclosure, so such modifications, improvements, and corrections still belong to the spirit and scope of the exemplary embodiments of the present disclosure.

Meanwhile, the present disclosure uses specific words to describe the embodiments of the present disclosure. For example, “one embodiment,” “an embodiment,” and/or “some embodiments” refer to a certain feature, structure or characteristic related to at least one embodiment of the present disclosure. Therefore, it should be emphasized and noted that references to “one embodiment” or “an embodiment” or “an alternative embodiment” two or more times in different places in the present disclosure do not necessarily refer to the same embodiment. In addition, certain features, structures or characteristics in one or more embodiments of the present disclosure may be properly combined.

In addition, unless clearly stated in the claims, the sequence of processing elements and sequences described in the present disclosure, the use of counts and letters, or the use of other names are not used to limit the sequence of processes and methods in the present disclosure. While the foregoing disclosure has discussed by way of various examples some embodiments of the invention that are presently believed to be useful, it should be understood that such detail is for illustrative purposes only and that the appended claims are not limited to the disclosed embodiments, but rather, the claims are intended to cover all modifications and equivalent combinations that fall within the spirit and scope of the embodiments of the present disclosure. For example, although the implementation of various components described above may be embodied in a hardware device, it may also be implemented as a software only solution, e.g., an installation on an existing server or mobile device.

In the same way, it should be noted that in order to simplify the expression disclosed in this disclosure and help the understanding of one or more embodiments of the invention, in the foregoing description of the embodiments of the present disclosure, sometimes multiple features are combined into one embodiment, drawings or descriptions thereof. This manner of disclosure does not, however, imply that the subject matters of the disclosure requires more features than are recited in the claims. Rather, claimed subject matters may lie in less than all features of a single foregoing disclosed embodiment.

Each of the patents, patent applications, publications of patent applications, and other material, such as articles, books, specifications, publications, documents, things, and/or the like, referenced herein is hereby incorporated herein by this reference in its entirety for all purposes, excepting any prosecution file history associated with same, any of same that is inconsistent with or in conflict with the present document, or any of same that may have a limiting affect as to the broadest scope of the claims now or later associated with the present document. By way of example, should there be any inconsistency or conflict between the description, definition, and/or the use of a term associated with any of the incorporated material and that associated with the present document, the description, definition, and/or the use of the term in the present document shall prevail.

In closing, it is to be understood that the embodiments of the present disclosure disclosed herein are illustrative of the principles of the embodiments of the present disclosure. Other modifications that may be employed may be within the scope of the present disclosure. Thus, by way of example, but not of limitation, alternative configurations of the embodiments of the present disclosure may be utilized in accordance with the teachings herein. Accordingly, embodiments of the present disclosure are not limited to that precisely as shown and described.

What is claimed is:

1. A system for controlling multi-UAV cooperative tracking of a ground-moving target, comprising unmanned aerial vehicles (UAVs), a processor, and a storage device; wherein the UAVs are wirelessly communicatively connected to the processor, the processor is configured to generate a UAV command transmitted to the UAVs, the UAVs are configured to transmit tracking data to the processor, and the processor includes:
a terrain building module configured to:
control the UAVs to fly in a flight area based on a flight environment and the flight area in which the UAVs are flying, collect coordinate information in the flight area, and generate a three-dimensional (3D) coordinate map;
generate obstacle information based on an area occupied by a building of a building complex, a height of the building, a central position of the building on the ground, a central position area, and a count of buildings of the building complex;
a flight simulation module configured to:
generate a first dynamic model based on a horizontal position coordinate, a first velocity, a first heading angle, and a first angular velocity of the ground-moving target, and store the first dynamic model in the storage device, the first dynamic model being configured to characterize a moving characteristic of the ground-moving target;
generate a second dynamic model based on a position coordinate, a second velocity, a second heading angle, and a second angular velocity of each of the UAVs, and store the second dynamic model in the storage device, the second dynamic model being configured to characterize a moving characteristic of the UAVs;
generate a total cost model for target tracking control based on a horizontal distance model, an obstacle avoidance model, a coverage model, a safety distance model, a communication distance model, and an energy consumption model, and store the total cost model in the storage device;
a UAV parameter generation module configured to:
for each of the UAVs, generate a guidance function for an input control variable of the UVA based on a horizontal distance between the UAV and the ground-moving target, a predicted count of steps of a subsequent trajectory of the UAV, an extreme value of the input control variable of the UAV, an angle between a flight direction of the UAV and a moving direction of the ground-moving target, a maximum distance at which the UAV effectively tracks the ground-moving target, the input control variable including the second velocity and the second angular velocity;
generate an input constraint for the input control variable;
generate a plurality of subsequent control sequences based on the input constraint and the guidance function, while satisfying a performance constraint of each of the UAVs, the performance constraint including at least one of a flight velocity, a turning angle, and a flight altitude of the UAV;
a flight trajectory prediction module configured to:
receive current status information of the UAVs transmitted by the UAVs; and
predict a plurality of subsequent flight trajectories based on the current status information, the second dynamic model, and the plurality of subsequent control sequences;
a flight track determination module configured to:
generate an adaptation value for each of the plurality of subsequent flight trajectories based on the total cost model;
generate an optimal subsequent trajectory for the UAVs based on adaptation values for the plurality of subsequent flight trajectories; and
a flight trajectory control module configured to:
send a flight input sequence corresponding to the optimal subsequent trajectory to a corresponding UAV via a mobile network.

2. The system of claim 1, wherein the processor is configured to:
S1: designate an urban topography as the flight environment, and construct the 3D coordinate map, the obstacle information, the first dynamic model, the second dynamic model, and the total cost model based on the flight environment and the flight area;
construct the 3D coordinate map by the UAVs in the flight area using an X-axis and a Y-axis of a ground area, and a flight altitude above the ground area as a Z-axis;
determine a threat boundary and the height of the building complex by approximating a threat area as a rectangular area,
the obstacle information is represented as: ξ=∪_{B=1}^{B=N}^{₁}ξ_{B}, ξ_{B}=F(H_{B}, (x, y))∈X̅_{B}
wherein ξ_{B} denotes an area occupied by any one of the building of the building complex, as function of the height H_{B} of the building and the central position (x, y) of the building on the ground, X_{B} denotes the central position area, and N₁ denotes the count of the buildings of the building complex;
construct the first dynamic model under an inertial system without considering an influence of external factors on the movement of the UAVs:
\dot{x}_{T}=ν_{T} sin θ_{T}, \dot{y}_{T}=ν_{T} cos θ_{T}, \dot{θ}_{T}=ω_{T}
wherein (x_{T}, y_{T}) denotes the horizontal position coordinate of the ground-moving target; and ν_{T}, θ_{T}, ω_{T} denote the first velocity, the first heading angle, and the first angular velocity, respectively;
assuming the UAVs fly at a fixed altitude between urban buildings, construct the second dynamic model without considering the influence of the external factors on the movement of the UAVs:
\dot{x}=νᵢ sin θᵢ, \dot{y}ᵢ=νᵢ cos θᵢ, żᵢ=0, \dot{θ}ᵢ=ωᵢ,
wherein xᵤᵢ=(xᵢ, yᵢ, zᵢ) denotes a position coordinate of an i^{th} UAV; νᵢ and θᵢ denote an i^{th} second velocity and an i^{th} second heading angle, respectively; ωᵢ denotes an i^{th} second angular velocity; rᵢ=(νᵢ, ωᵢ) denotes an input control variable of the i^{th} UAV, i=1, 2, . . . , N₂, N₂ denotes a count of the UAVs;
generate the total cost model based on a weighted algebraic sum of the horizontal distance model, denoted as J_{D}, the obstacle avoidance model, denoted as J_{OA}, the coverage model, denoted as J_{C}, the safety distance model, denoted as J_{SD}, the communication distance model, denoted as J_{CD}, and the energy consumption model, denoted as J_{EC};
the total cost model is represented by:
$${f}_{N , G} = {m}_{1} \cdot {J}_{D} + {m}_{2} \cdot {J}_{OA} + {m}_{3} \cdot {J}_{C} + {m}_{4} \cdot {J}_{SD} + {m}_{5} \cdot {J}_{CD} + {m}_{6} \cdot {J}_{EC}$$
wherein m₁, m₂, m₃, m₄, m₅, and m₆ denote first weight coefficients of a horizontal distance cost, an obstacle avoidance cost, a target coverage cost, a safety distance cost, a communication distance cost, and an energy consumption cost, respectively;
S2: set the input constraint and the guidance function for the input control variable based on the models constructed in S1, and generate N3 the subsequent control sequences based on the input constraint and the guidance function, while satisfying the performance constraint of the UAVs;
the performance constraint includes the flight velocity, the turning angle, and the flight altitude of the UAVs; and the input control variable includes the second velocity vi and the second angular velocity ωᵢ,
construct the guidance function using a mathematical model expressed as:
$${g}_{M} = \frac{1}{( 1 + {e}^{( c θ r )} )} ( ub - lb ) + lb if d > l ,$$
wherein d denotes the horizontal distance between the UAV and the ground-moving target, M denotes the predicted count of steps of the subsequent trajectory of the UAV, ub and lb denote a maximum value and a minimum value of the input control variable, respectively, θ denote the angle between the flight direction of the UAV and the moving direction of the ground-moving target, and l denotes the a maximum distance at which the UAV effectively track the ground-moving target, determined based on a type of a sensor of the UAV; c is a constant parameter, and r is a random number in (0, 1);
S3, predict N3 subsequent flight trajectories using the N3 subsequent control sequences obtained S2 based on the current status information and the second dynamic model constructed in S1;
S4, define a population of an improved whale optimization algorithm based on the N3 subsequent control sequences obtained in S3, wherein each subsequent control sequence corresponds to an individual in the population, evaluate each individual in the population based on the total cost model constructed in S1, and determine an evaluation result as the adaptation value;
S5, determine whether a count of iterations in the improved whale optimization algorithm in S4 is equal to a maximum count of iterations; in response to the count of iterations reaching the maximum count of iterations, select an individual with a smallest adaptation value as the optimal subsequent trajectory based on adaptation values of individuals of each generation of the population obtained in S4; in response to the count of iterations not reaching the maximum count of iterations, update each individual using the improved whale optimization algorithm, and select the optimal subsequent trajectory after a set count of optimized generations;
wherein a process of updating each individual using the improved whale optimization algorithm includes:
S51, an initialization phase:
updating vector coefficients A and C, and a parameter a in the whale optimization algorithm,
$$A = 2 \cdot a \cdot {r}_{1} - a , C = 2 \cdot {r}_{2} , a = 2 - \frac{2 \cdot t}{{T}_{max}} ,$$
wherein r₁ is a random number in (0,1) and a is a number whose value decreases linearly from 2 to 0; r₂ is a random number in (0,1); t denotes a current count of iterations, and Tₘₐₓ denotes the maximum count of iterations;
S52, a searching phase:
if p≤λ, then the whale optimization algorithm enters into the searching phase, wherein p is a random number in (0, 1), λ denotes a set parameter whose value varies with the count of iterations,
$$λ = \frac{t}{{T}_{max}} ,$$
and a classic differential mutation strategy and a random differential mutation strategy are used in the searching phase;
the classic differential mutation strategy is expressed as:
$${X}_{1 , i} ( t + 1 ) = {X}^{*} ( t ) + F \cdot ( {X}_{rand 1} ( t ) - {X}_{rand 2} ( t ) ) ,$$
wherein X*(t) denotes an optimal individual in the population before a generation t, which is an optimal predicted input sequence, X_{rand1}(t) and X_{rand2}(t) denote two different individuals in the generation t, which are two different predicted input sequences, and F is a scaling factor;
the random differential mutation strategy is expressed as:
$${X}_{2 , i} ( t + 1 ) = {r}_{1} \cdot ( {X}^{*} ( t ) - {X}_{i} ( t ) ) + {r}_{2} \cdot ( {X}_{rand 3} ( t ) - {X}_{i} ( t ) ) ,$$
wherein r₁ and r₁ are random numbers in (0,1), X*(t) denotes the optimal individual in the population before the generation t, X_{rand3}(t) denotes an individual in the generation t, which is a random predicted input sequence, and Xᵢ(t) denotes an i^{th} individual in the generation t, which is an i^{th} predicted input sequence;
the above two strategies are selected based on equations as follows:
$${X}_{i} ( t + 1 ) = \{ \begin{matrix}{X}_{1 , i} ( t + 1 ) & rand \leq CR or j = {j}_{rand} & j = 1 , 2 , … , N \\ {X}_{2 , i} ( t + 1 ) & otherwise & \end{matrix} ,$$
wherein Xᵢ(t+1) denotes an i^{th} individual in a generation (t+1), which is the i^{th} predicted input sequence; j_{rand} is a randomly generated integer between 1 and N, and CR denotes a randomly generated crossover probability between 0 and 1;
S53, an encircling prey phase:
if p<λ, then the whale optimization algorithm enters into the encircling prey phase, and an encircling-and-surrounding prey strategy and a spiral-update prey strategy are used in the encircling prey phase;
the encircling-and-surrounding prey strategy is expressed as:
$${X}_{3 , i} ( t + 1 ) = ω \cdot {X}^{*} ( t ) - A \cdot D ,$$
the spiral-update prey strategy is expressed as:
$${X}_{4 , i} ( t + 1 ) = ω \cdot {X}^{*} ( t ) + D \cdot {e}^{bl} \cdot cos ( 2 π l ) ,$$
the above two strategies are selected based on an equation as follows:
$${X}_{i} ( t + 1 ) = \{ \begin{matrix}{X}_{3 , i} ( t + 1 ) & q \leq 0.5 \\ {X}_{4 , i} ( t + 1 ) & q > 0.5\end{matrix} ,$$
wherein ω denotes a second weight coefficient determined adaptively; D denotes a distance between a current individual and the optimal individual, which is a distance between a current predicted trajectory and a trajectory corresponding to the optimal individual; b denotes a spiral shape parameter, l denotes a cycle parameter, whose value is a random number in (−1,1), and q denotes a probability of randomly selecting a predation mode; X*(t) denotes the optimal individual in the population before the generation t, and Xₜ(t) denotes the i^{th} individual in the generation t, which is the i^{th} predicted input sequence;
S54, an offspring update phase:
selecting the optimal individual as an offspring individual using an elite selection strategy;
the elite selection strategy is expressed as:
$${X}_{i} ( t + 1 ) = \{ \begin{matrix}{X}_{i} ( t ) & f ( {X}_{l , i} ( t + 1 ) ) > f ( {X}_{i} ( t ) ) \\ {X}_{i} ( t + 1 ) & else\end{matrix} ,$$
wherein Xᵢ(t) denotes the i^{th} individual in the generation t, which is the i^{th} predicted input sequence, and Xᵢ(t+1) denotes the i^{th} individual in the generation (t+1), which is the i^{th} predicted input sequence; and
S6, transform the optimal subsequent trajectory selected in S5 to the subsequent control sequences corresponding to the UAVs based on the second dynamic model constructed in S1, wherein a first item of each of the subsequent control sequences is a next flight control input of a corresponding UAV; repeat the operations S2 to S6 until obtaining flight input sequences during the entire tracking process of the ground-moving target, and obtain an optimal trajectory for the multi-UAV cooperative tracking of the ground-moving target.

3. The system of claim 2, wherein the processor is further configured to:
set boundary constraints of the flight area based on the flight environment in S1, and obtain the flight area by the boundary constraints; the boundary constraints including a boundary constraint on directions of the X-axis and the Y-axis in a horizontal plane, and a boundary constraint on a direction of the Z-axis.

4. The system of claim 2, wherein in S1,
the horizontal distance model is expressed as:
$${J}_{D} = \{ \begin{matrix}{\sum }_{j = k}^{k + {N}_{4} - 1} {\sum }_{i = 1}^{{N}_{2}} \frac{{l}_{iT} ( j )}{L} & {l}_{iT} < L \\ {\sum }_{j = k}^{k + {N}_{4} - 1} {\sum }_{i = 1}^{{N}_{2}} {l}_{iT} ( j ) & {l}_{iT} > L\end{matrix} , {l}_{iT} = \sqrt{{( {x}_{{U}_{i}} - {x}_{T} )}^{2} - {( {y}_{{U}_{i}} - {y}_{T} )}^{2}} ,$$
wherein J_{D} denotes the horizontal distance cost between the UAVs and the ground-moving target in a horizontal plane, N₄ denotes a predicted count of steps of the movement of the UAV, N₂ denotes the count of the UAVs, l_{iT} denotes a horizontal distance between the i^{th} UAV and the ground-moving target, L is a constant;
the obstacle avoidance model is represented as:
$${J}_{oA} = {\sum }_{j = k}^{k + {N}_{4} - 1} {\sum }_{i = 1}^{{N}_{U}} {g}_{i} ( j ) , {g}_{i} = \{ \begin{matrix}0 & {p}_{c} ( {h}_{nfz} - {z}_{{U}_{i}} ) < 0 \\ ∞ & {p}_{c} ( {h}_{nfz} - {z}_{{U}_{i}} ) > 0\end{matrix} ,$$
wherein J_{OA} denotes the obstacle avoidance cost between the UAVs and an obstacle, gᵢ denotes a penalty function for the collision of the UAVs with a building of the building complex, h_{nfz} denotes a height of the obstacle, z_{Ui} denotes a flight altitude of the i^{th} UAV; p_{c} denotes a probability of collision between the UAVs and the building in a horizontal direction, if the UAVs collide with a boundary of the building, p_{c}=1, if the UAVs do not collide with the boundary of the building, p_{c}=0;
the coverage model is expressed as:
$${J}_{C} = \{ \begin{matrix}{\sum }_{j = k}^{k + {N}_{4} - 1} {\sum }_{i = 1}^{{N}_{U}} {P}_{i} {P}_{T} ( j ) & ∃ i \vert {P}_{i} > p and {P}_{T} = 1 \\ 0 & else\end{matrix} ,$$
$${P}_{i} = ρ * exp ( - c ( {( {x}_{{U}_{i}} - {x}_{T} )}^{2} + {( {y}_{{U}_{i}} - {y}_{T} )}^{2} + {( {z}_{{U}_{i}} - {z}_{T} )}^{2} ) ) , \\ {P}_{T} = \{ \begin{matrix}0 the UAV having an \\ obstructed line - of - sight to the ground - moving target \\ 1 the UAV having an \\ unobstructed line - of - sight to the ground - moving target\end{matrix} ,$$
wherein J_{C} denotes the target coverage cost of the UAVs' target tracking, Pᵢ denotes a probability that the ground-moving target is detected by the i^{th} UAV, p denotes a probability that the UAVs detect the ground-moving target, P_{T} denotes a probability of a line-of-sight between the UAVs and the ground-moving target being obstructed, (x_{T}, y_{T}, z_{T}) denotes a position coordinate of the ground-moving target;
the safety distance model is expressed as:
$${J}_{SD} = {\sum }_{j = k}^{k + {N}_{4} - 1} {\sum }_{i = 1}^{{N}_{U}} {f}_{SDi} ( j ) , {f}_{SDi} = \frac{1}{2} [ 1 - tanh ( \frac{{d}_{ij} - {d}_{min} - \frac{Δ d}{2}}{\frac{Δ d}{8}} ) ] ,$$
where J_{SD} denotes the safety distance cost between the UAVs, dᵢⱼ denotes a distance between the i^{th} UAV and a j^{th} UAV, dₘᵢₙ denotes a minimum safe distance between the UAVs, and Δd denotes a buffer distance of the UAVs;
the communication distance model is expressed as:
$${J}_{CD} = {\sum }_{j = k}^{k + {N}_{4} - 1} {\sum }_{i = 1}^{{N}_{U}} {f}_{CDi} ( j ) , {f}_{CDi} = \frac{1}{2} [ 1 + tanh ( \frac{{d}_{ij} - {d}_{max} + \frac{Δ d}{2}}{\frac{Δ d}{8}} ) ] ,$$
wherein J_{CD} denotes the communication distance cost between the UAVs, dᵢⱼ denotes the distance between the i^{th} UAV and the j^{th} UAV, dₘₐₓ denotes a maximum communication distance between the UAVs, and Δd denotes the buffer distance of the UAVs; and
the energy consumption model is expressed as:
$${J}_{EC} = {\sum }_{j = k}^{k + {N}_{4} - 1} {\sum }_{i = 1}^{{N}_{U}} \frac{‖ {v}_{i} ( j ) - {v}_{i} ( j - 1 ) ‖}{{v}_{max} - {v}_{min}} + \frac{‖ {ω}_{i} ( j ) - {ω}_{i} ( j - 1 ) ‖}{{ω}_{max} - {ω}_{min}} ,$$
wherein J_{EC} denotes the energy consumption cost of the UAVs' target tracking, ωᵢ and νᵢ are the input control variables of the UAVs, νₘₐₓ denotes a maximum velocity of the UAVs, νₘᵢₙ denotes a minimum velocity of the UAVs, ωₘₐₓ denotes a maximum angular velocity of the UAVs, and ωₘᵢₙ denotes a minimum angular velocity of the UAVs.

5. The system of claim 2, wherein in the operations S2˜S4, N subsequent control sequences are represented as:
$$( {v}_{1 , i} , {ω}_{1 , i} ) , ( {v}_{1 , i + 1} , {ω}_{1 , i + 1} ) , ( {v}_{1 , i + 2} , {ω}_{1 , i + 2} ) , … , ( {v}_{1 , i + M} , {ω}_{1 , i + M} ) , \\ ( {v}_{2 , i} , {ω}_{2 , i} ) , ( {v}_{2 , i + 1} , {ω}_{2 , i + 1} ) , ( {v}_{2 , i + 2} , {ω}_{2 , i + 2} ) , … , ( {v}_{2 , i + M} , {ω}_{2 , i + M} ) , \\ ( {v}_{3 , i} , {ω}_{3 , i} ) , ( {v}_{2 , i + 1} , {ω}_{2 , i + 1} ) , ( {v}_{3 , i + 2} , {ω}_{3 , i + 2} ) , … , ( {v}_{3 , i + M} , {ω}_{3 , i + M} ) , \\ … \\ ( {v}_{N , i} , {ω}_{N , i} ) , ( {v}_{N , i + 1} , {ω}_{N , i + 1} ) , ( {v}_{N , i + 2} , {ω}_{N , i + 2} ) , … , ( {v}_{N , i + M} , {ω}_{N , i + M} ) ;$$
N predicted subsequent flight trajectories are represented as:
$$( {x}_{1 , i} , {y}_{1 , i} , {z}_{1 , i} , {φ}_{1 , i} ) , ( {x}_{1 , i + 1} , {y}_{1 , i + 1} , {z}_{1 , i + 1} , {φ}_{1 , i + 1} ) , \\ ( {x}_{1 , i + 2} , {y}_{1 , i + 2} , {z}_{1 , i + 2} , {φ}_{1 , i + 2} ) , … , ( {x}_{1 , i + M} , {y}_{1 , i + M} , {z}_{1 , i + M} , {φ}_{1 , i + M} ) , \\ ( {x}_{2 , i} , {y}_{2 , i} , {z}_{2 , i} , {φ}_{2 , i} ) , ( {x}_{2 , i + 1} , {y}_{2 , i + 1} , {z}_{2 , i + 1} , {φ}_{2 , i + 1} ) , \\ ( {x}_{2 , i + 2} , {y}_{2 , i + 2} , {z}_{2 , i + 2} , {φ}_{2 , i + 2} ) , … , ( {x}_{2 , i + M} , {y}_{2 , i + M} , {z}_{2 , i + M} , {φ}_{2 , i + M} ) , \\ ( {x}_{3 , i} , {y}_{3 , i} , {z}_{3 , i} , {φ}_{3 , i} ) , ( {x}_{3 , i + 1} , {y}_{3 , i + 1} , {z}_{3 , i + 1} , {φ}_{3 , i + 1} ) , \\ ( {x}_{3 , i + 2} , {y}_{3 , i + 2} , {z}_{3 , i + 2} , {φ}_{3 , i + 2} ) , … , ( {x}_{3 , i + M} , {y}_{3 , i + M} , {z}_{3 , i + M} , {φ}_{3 , i + M} ) , \\ … \\ ( {x}_{N , i} , {y}_{N , i} , {z}_{N , i} , {φ}_{N , i} ) , ( {x}_{N , i + 1} , {y}_{N , i + 1} , {z}_{N , i + 1} , {φ}_{N , i + 1} ) , \\ ( {x}_{N , i + 2} , {y}_{N , i + 2} , {z}_{N , i + 2} , {φ}_{N , i + 2} ) , … , ( {x}_{N , i + M} , {y}_{N , i + M} , {z}_{N , i + M} , {φ}_{N , i + M} ) ;$$
and
adaptation values for the N subsequent flight trajectories are represented as:
$${f}_{1 , 1} , {f}_{2 , 1} , {f}_{3 , 1} , … , {f}_{N , 1} , \\ {f}_{1 , 2} , {f}_{2 , 2} , {f}_{3 , 2} , … , {f}_{N , 2} , \\ {f}_{1 , 3} , {f}_{2 , 3} , {f}_{3 , 3} , … , {f}_{N , 3} , \\ … \\ {f}_{1 , t} , {f}_{2 , t} , {f}_{3 , t} , … , {f}_{N , t} ;$$
wherein, f_{N,t} denotes the adaptation values for the subsequent flight trajectories, N denotes a number of a predicted trajectory, N∈[1, N₃]; t denotes the current count of iterations, t∈[1, Tₘₐₓ], and Tₘₐₓ denotes the maximum count of iterations.

6. The system of claim 2, wherein in S53, the second weight coefficient ω is expressed as:
$$ω = 1 - \frac{{e}^{\frac{t}{{T}_{max}}} - 1}{e - 1} .$$

7. The system of claim 1, wherein the processor is further configured to:
obtain historical tracking data transmitted by the UAVs to the processor; and
dynamically adjust the first weight coefficient of each cost based on a change of the historical tracking data.

8. The system of claim 1, wherein the processor is further configured to:
in response to a UAV of the UAVs identifying the ground-moving target and the UAV having an unobstructed line-of-sight to the ground-moving target, determine the UAV as a target UAV and obtain tracking data of an associated UAV corresponding to the target UAV;
adjust the optimal subsequent trajectory of the associated UAV tracking the ground-moving target based on the tracking data of the associated UAV;
update the flight input sequence for the associated UAV based on an adjustment result;
generate the UAV command based on an updated flight input sequence; and
send the UAV command to the associated UAV, such that the associated UAV flies in accordance with the updated flight input sequence.

9. The system of claim 8, wherein the processor is further configured to:
in response to the target UAV being unable to identify the ground-moving target for a subsequent preset period after the target UAV initially identifies the ground-moving target, determine that the target UAV has an obstructed line-of-sight to the ground-moving target.

10. The system of claim 8, wherein the processor is further configured to:
generate a plurality of candidate adjusted trajectories;
for a candidate adjusted trajectory, determine a predicted energy consumption amount of the associated UAV using a UAV energy consumption model based on an initial optimal subsequent trajectory of the associated UAV, the candidate adjusted trajectory, wind force and direction data, flight altitude data of the associated UAV, and a current energy level of the associated UAV, the UAV energy consumption model being a neural network model; and
adjust the optimal subsequent trajectory of the associated UAV tracking the ground-moving target based on predicted energy consumption amounts of the plurality of candidate adjusted trajectories.

11. The system of claim 8, wherein the processor is further configured to:
obtain a plurality of training samples and labels, each of the training samples including a sample initial optimal subsequent trajectory of a sample UAV, a sample candidate adjusted track, sample wind force and direction data, sample flight altitude data of the sample UAV, and a sample current energy level of the sample UAV, the label of a training sample including a sample predicted energy consumption amount of the sample UAV corresponding to the training sample;
set a plurality of training sets and a learning rate corresponding to each of the plurality of training sets based on at least one of the sample current energy level and a trajectory complexity of sample UAVs;
train an initial UAV energy consumption model based on the learning rate of the plurality of training sets, the plurality of training samples, and labels; and
acquire the UAV energy consumption model until a trained UAV energy consumption model satisfies a first predetermined condition.

12. The system of claim 1, wherein the processor is further configured to:
perform iterations based on an initial selection probability;
in response to a count of the iterations reaching a predetermined count, determine, for each set of individuals generated during all iterations, a first count of instances in which an optimal individual is generated from the encircling-and-surrounding prey strategy and a second count of instances in which the optimal individual is generated from the spiral-update prey strategy;
determine a magnitude of change between a tracking result of the UVAs flying according to a current optimal subsequent trajectory and a tracking result of the UVAs flying according to a previous optimal subsequent trajectory; and
adjust a probability of randomly selecting a predation mode based on the magnitude of change, the first count, and the second count.

13. The system of claim 6, wherein the processor is further configured to:
determine a predicted remaining energy level based on a current energy level and a predicted energy consumption amount; and
adjust the second weight coefficient based on the predicted remaining energy level.

14. A method for controlling multi-UAV cooperative tracking of a ground-moving target, the method comprising:
controlling UAVs to fly in a flight area based on a flight environment and the flight area in which the UAVs are flying, collecting coordinate information in the flight area, and generating a three-dimensional (3D) coordinate map;
generating obstacle information based on an area occupied by a building of a building complex, a height of the building, a central position of the building on the ground, a central position area, and a count of buildings of the building complex;
generating a first dynamic model based on a horizontal position coordinate, a first velocity, a first heading angle, and a first angular velocity of the ground-moving target, and storing the first dynamic model in the storage device, the first dynamic model being configured to characterize a moving characteristic of the ground-moving target;
generating a second dynamic model based on a position coordinate, a second velocity, a second heading angle, and a second angular velocity of each of the UAVs, and storing the second dynamic model in the storage device, the second dynamic model being configured to characterize a moving characteristic of the UAVs;
generating a total cost model for target tracking control based on a horizontal distance model, an obstacle avoidance model, a coverage model, a safety distance model, a communication distance model, and an energy consumption model, and storing the total cost model in the storage device;
for each of the UAVs, generating a guidance function for an input control variable of the UVA based on a horizontal distance between the UAV and the ground-moving target, a predicted count of steps of a subsequent trajectory of the UAV, an extreme value of the input control variable of the UAV, an angle between a flight direction of the UAV and a moving direction of the ground-moving target, a maximum distance at which the UAV effectively tracks the ground-moving target, the input control variable including the second velocity and the second angular velocity;
generating an input constraint for the input control variable;
generating a plurality of subsequent control sequences based on the input constraint and the guidance function, while satisfying a performance constraint of each of the UAVs, the performance constraint including at least one of a flight velocity, a turning angle, and a flight altitude of the UAV;
receiving current status information of the UAVs transmitted by the UAVs;
predicting a plurality of subsequent flight trajectories based on the current status information, the second dynamic model, and the plurality of subsequent control sequences;
generating an adaptation value for each of the plurality of subsequent flight trajectories based on the total cost model;
generating an optimal subsequent trajectory for the UAVs based on adaptation values for the plurality of subsequent flight trajectories; and
sending a flight input sequence corresponding to the optimal subsequent trajectory to a corresponding UAV via a mobile network.
